(19) United States
(12) Patent Application Publication
(10) Pub. No.: US 2014/0379100 A1
(43) Pub. Date: Dec. 25, 2014

(54) METHOD FOR REQUESTING CONTROL AND INFORMATION PROCESSING APPARATUS FOR SAME

(71) Applicant: FUJITSU LIMITED, Kawasaki-shi (JP)

(72) Inventors: Toru Kitayama, Kobe (JP); Jun Yoshii, Nagoya (JP); SHOTARO OKADA, Nishinomiya (JP); Akinobu Takaishi, Kobe (JP); Toshitsugu Mori, Akashi (JP); Ryota Kawagata, KOBE (JP); Yukihiro Takeuchi, Akashi (JP); Keigo Mitsumori, Koube (JP)

(21) Appl. No.: 14/313,319

(22) Filed: Jun. 24, 2014

(30) Foreign Application Priority Data
Jun. 25, 2013 (JP) 2013-132543

(51) Int. Cl. G05B 15/02

(52) U.S. Cl. CPC G05B 15/02
USPC 700/20

(57) ABSTRACT

In an information processing apparatus, a selection unit selects one of a plurality of controller apparatuses to control a controlled apparatus, based on transmission rates of communication links between the controlled apparatus and the plurality of controller apparatuses. A requesting unit then requests the selected controller apparatus to control the controlled apparatus.

### CROSS-REFERENCE TO RELATED APPLICATION

This application is based upon and claims the benefit of priority of the prior Japanese Patent Application No. 2013-132543, filed on Jun. 25, 2013, the entire contents of which are incorporated herein by reference.

### FIELD

The embodiments discussed herein relate to a method for requesting control and also to an information processing apparatus for the same.

### BACKGROUND

Enterprise information and communications technology (ICT) systems and data centers are operated with software programs designed to automate operations management (e.g., power management of servers) to alleviate the burden of such tasks. The term “management server” will be used herein to refer to a server that offers operations management capabilities by using such automation software, while the servers under the control of this management server will be called “managed servers.” For example, the management server operates the entire system by remotely controlling managed servers in accordance with a specific process defined as a workflow.

With the growing scale of computer systems, the management server takes care of an increasing number of managed servers. The management server may sometimes need to execute two or more workflows at the same time. Such concurrent execution of multiple workflows across a large number of managed servers would overwhelm the management server with an excessive load and thus result in a noticeable delay of its control operations. A computer system may encounter this type of problematic situation when, for example, it is informed that a scheduled power outage is coming soon. The management server now has to stop the operation of many managed servers before the power is lost, but the available time may be too short to close all servers.

As one technique to avoid excessive load on a management server, it is proposed to execute a series of processing operations by successively invoking one or more software components deployed in a plurality of servers. This technique includes making some estimates about the total amount of computational load caused by a group of software components, assuming that each execution request of software components is sent to one of possible servers. Based on the estimates, one of those possible servers is selected for each software component, as the destination of an execution request. Also proposed is a computer system configured to perform task scheduling with a consideration of the network distance between computers so as to increase the efficiency of the system as a whole. See, for example, the following

### DOCUMENTS

Japanese Laid-open Patent Publication No. 2007-257163
Japanese Laid-open Patent Publication No. 2005-310120

As a possible implementation of a computer system, several servers may be assigned the role of controlling managed servers in the system. The system determines which server will take care of which managed servers. Conventional techniques for this determination, however, do not consider the performance of communication between controlling servers and controlled servers (or managed servers). As a result of this lack of consideration, an inappropriate server could be assigned to a group of managed servers in spite of its slow network link with those managed servers. In other words, there is room for improvement of efficiency in the technical field of automated operations management of servers.

The above examples have assumed that a plurality of managed servers are controlled via networks. It is noted, however, that other kinds of devices may be controlled similarly, and that the same problems discussed above may apply to them as well.

### SUMMARY

According to one aspect of the embodiments, there is provided a non-transitory computer-readable medium storing a computer program that causes a computer to perform a process including: selecting a controller apparatus from a plurality of controller apparatuses to control a controlled apparatus, based on transmission rates of communication links between the controlled apparatus and each of the plurality of controller apparatuses; and requesting the selected controller apparatus to control the controlled apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary system configuration according to a first embodiment;

FIG. 2 illustrates an exemplary system configuration according to a second embodiment;

FIG. 3 illustrates an exemplary hardware configuration of a management server;

FIG. 4 is a functional block diagram of a management server and execution servers;

FIG. 5 illustrates an example of a process definition;

FIG. 6 is a flowchart illustrating an exemplary process of updating configuration data;

FIG. 7 illustrates an exemplary data structure of a configuration management database;

FIG. 8 is a flowchart illustrating an exemplary process of automated flow execution;

FIG. 9 is a flowchart illustrating an exemplary process of process definition analysis;

FIG. 10 exemplifies a node-vs-server management table;

FIG. 11 illustrates a first example of an automated flow;

FIG. 12 illustrates a second example of an automated flow;

FIG. 13 illustrates a third example of an automated flow;

FIG. 14 illustrates a fourth example of an automated flow;

FIG. 15 is a flowchart illustrating an exemplary process of grouping nodes;

FIG. 16 is a flowchart illustrating an example of a grouping routine for manipulation component nodes;

FIG. 17 is a flowchart illustrating an example of a grouping routine for parallel branch;

FIG. 18 is a flowchart illustrating an example of a grouping routine for conditional branch;

FIG. 19 illustrates an exemplary data structure of a group management table;

FIG. 20 illustrates a first example of grouping;

FIG. 21 illustrates a second example of grouping;

FIG. 22 illustrates a third example of grouping;

FIG. 23 illustrates a fourth example of grouping;

FIG. 24 is a flowchart illustrating an exemplary process of performance analysis;

FIG. 25 illustrates an exemplary data structure of a communication performance management table;

FIG. 26 is a flowchart illustrating an exemplary process of execution server assignment;

FIG. 27 illustrates an exemplary data structure of an operation-assigned server management table;

FIG. 28 is a flowchart illustrating an exemplary process of automated flow execution;

FIG. 29 is a flowchart illustrating an exemplary process of automated flow execution by an execution server;

FIG. 30 illustrates how long time it takes to transfer a 100-megabyte file;

FIG. 31 illustrates an example of communication events produced during execution of grouped operations; and

FIG. 32 illustrates reduction of processing times in the second embodiment.

### DESCRIPTION OF EMBODIMENTS

Several embodiments will be described below with reference to the accompanying drawings. These embodiments may be combined with each other, unless they have contradictory features.

### (A) First Embodiment

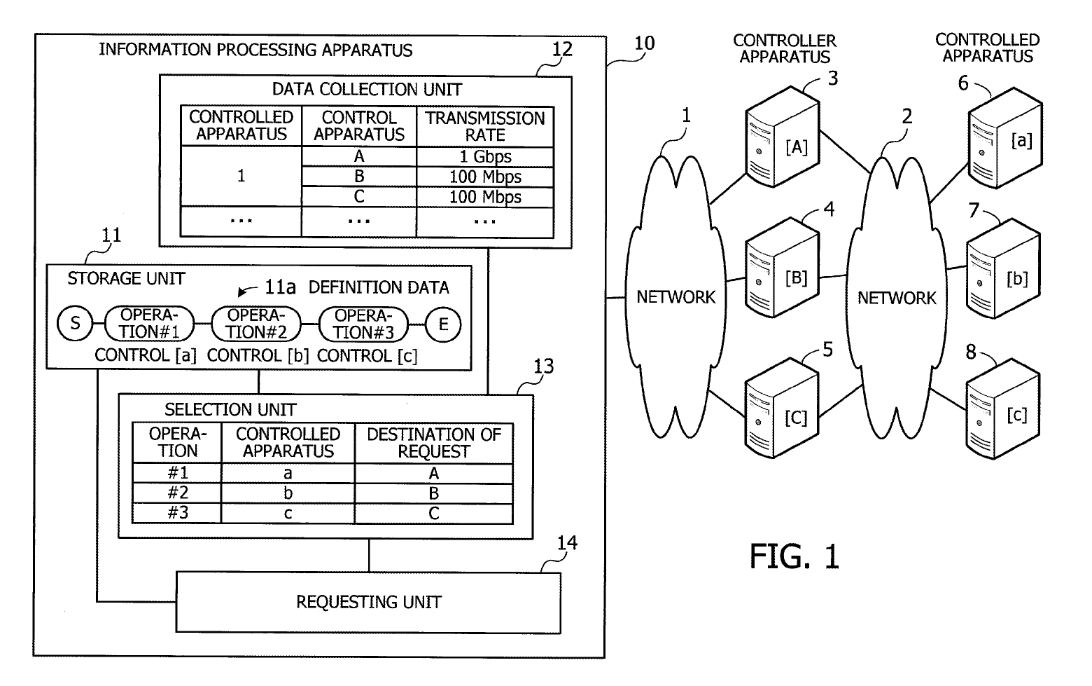

FIG. 1 illustrates an exemplary system configuration according to a first embodiment. The illustrated system includes, among others, an information processing apparatus 10 and a plurality of controller apparatuses 3 to 5 connected via a network 1. The controller apparatuses 3 to 5 are further linked to a plurality of controlled apparatuses 6 to 8 via another network 2. The controller apparatuses 3, 4, and 5 are distinguished by their respective identifiers [A], [B], and [C]. Similarly, the controlled apparatuses 6, 7, and 8 are distinguished by their respective identifiers [a], [b], and [c].

The controller apparatuses 3 to 5 manipulate the controlled apparatuses 6 to 8 in accordance with requests from the information processing apparatus 10. For example, the controller apparatus [A] 3 may start and stop some particular functions in the controlled apparatus [a] 6. The information processing apparatus 10 causes the controller apparatuses 3 to 5 to execute such manipulations for the controlled apparatus 6 to 8 in a distributed manner.

One thing to consider here is that controller apparatuses 3 to 5 may work with controlled apparatus 6 to 8 in various combinations, at various distances, and with various communication bandwidths over the network 2. This means that the efficiency of control operations depends on the decision of which controller apparatus to assign for which controlled apparatus. The first embodiment is therefore designed to make an appropriate assignment based on a rule that a controlled apparatus be combined with a controller apparatus that is able to communicate with the controlled apparatus at a higher speed than others.

The information processing apparatus 10 causes the controller apparatuses 3 to 5 to execute processing operations in a distributed manner, including control operations for some controlled apparatuses. The information processing apparatus 10 has thus to select a controller apparatus that can efficiently execute such control operations. To this end, the information processing apparatus 10 includes a storage unit 11, a data collection unit 12, a selection unit 13, and a requesting unit 14. Each of these components will be described below.

The storage unit 11 stores definition data 11a that defines a process of operations for manipulating a plurality of controlled apparatuses 6 to 8. For example, the definition data 11a gives the following three numbered operations. The first operation (#1) is to control one controlled apparatus [a] 6. The second operation (#2) is to control another controlled apparatus [b] 7. The third operation (#3) is to control yet another controlled apparatus [c] 8.

The data collection unit 12 collects information about transmission rates of communication links between each controller apparatus 3 to 4 and each controlled apparatus 6 to 8. The data collection unit 12 stores the collected information in a memory or other storage devices.

The selection unit 13 selects one of the controller apparatuses 3 to 5 for use with each of the controlled apparatuses 6 to 8, based on the transmission rates of communication links between the controller apparatuses 3 to 4 and the controlled apparatuses 6 to 8. For example, the selection unit 13 selects a particular controller apparatus to control a particular controlled apparatus when that controller apparatus has the fastest communication link to the controlled apparatus. The selection unit 13 may also consult definition data 11a stored in the storage unit 11 and select controller apparatuses depending on the individual operations defined in the definition data 11a.

The requesting unit 14 requests one of the controller apparatuses that has been selected by the selection unit 13 to control a particular controlled apparatus. For example, the requesting unit 14 follows the order of operations specified in the definition data 11a. With the progress of defined operations, the requesting unit 14 sends an execution request to the next controller apparatus selected by the selection unit 13.

The proposed system enables the controller apparatuses 3 to 5 to efficiently share their work of control operations for a number of controlled apparatuses 6 to 8. For example, operation #1 seen in the first step of the definition data 11a controls one apparatus 6. The information collected by the data collection unit 12 indicates that the controller apparatus [A] 3 has a faster communication link with the controlled apparatus 6 than other controller apparatuses 4 and 5. Based on this information, the selection unit 13 selects the controller apparatus [A] 3 as the destination of an execution request for operation #1. The requesting unit 14 then sends the execution request to the selected controller apparatus [A] 3. In response, the controller apparatus [A] 3 controls the controlled apparatus 6. The selection unit 13 also handles other operations #2 and #3 in a similar way, thus selecting controller apparatuses 4 and for controlled apparatuses 7 and 8, respectively, as being the fastest in terms of the transmission speeds. The requesting unit 14 sends an execution request for operation #2 to the controller apparatus [B] 4, as well as an execution request for operation #3 to the controller apparatus [A] 5. The controller apparatuses 3 to 5 thus execute a series of operations defined in the definition data 11a efficiently in a distributed fashion.

The information processing apparatus 10 may be configured to put a plurality of operations into a single group when they are a continuous series of operations for which the selection unit 13 has selected a common controller apparatus. The requesting unit 14 requests execution of all those operations in a group collectively to the selected common controller apparatus. This grouping feature reduces the frequency of communication events between the information processing apparatus 10 and controller apparatuses, thus contributing to more efficient execution of operations.

The definition data may include two or more operation sequences that are allowed to run in parallel with one another, each made up of a plurality of operations to be executed sequentially. It is more efficient if such parallel operation sequences are delegated to different controller apparatuses so as to take advantage of distributed processing. The information processing apparatus 10 thus subjects these operation sequences to the grouping mentioned above by, for example, producing one group from each different operation sequence. The information processing apparatus 10 issues execution requests to multiple controller apparatuses to initiate efficient distributed execution of parallel groups of operations.

The definition data may further include another kind of operation sequences each made up of a plurality of operations to be executed sequentially. Unlike the parallel ones discussed above, one of these operation sequences is selectively executed according to the decision of a conditional branch. The information processing apparatus 10 seeks a group in such conditional operation sequences as follows. For example, the information processing apparatus 10 checks the beginning part of one operation sequence to find one or more operations whose selected controller apparatuses are identical to the controller apparatus selected for a preceding operation immediately before the conditional branch. When such a match is found at the beginning part of the operation sequence, the information processing apparatus 10 then forms a group from the found operations and the preceding operation immediately before the conditional branch. This feature makes it possible to produce a larger group of operations and further reduce communication events between the information processing apparatus 10 and controller apparatuses.

Each issued execution request for a specific operation is supposed to reach its intended controller apparatus. The controller apparatus may, however, happen to be down at the time of arrival of a request due to some problem. In this situation, the selection unit 13 may reselect a controller apparatus for the failed operation, as well as for each of other pending operations subsequent thereto. The controller apparatus that has failed to receive the execution request is excluded from the reselection. The requesting unit 14 then requests the reselected controller apparatuses to execute the failed operation and other pending operations, respectively. In spite of the problem with a controller apparatus during the course of processing operations, the noted features of the selection unit 13 and requesting unit 14 permit the information processing apparatus 10 to perform a quick fail-over of controller apparatuses and continue the execution as defined in the definition data.

It is noted that the information processing apparatus 10 may itself be a controller apparatus. That is, the information processing apparatus 10 may include the functions for manipulating controlled apparatuses 6 to 8. Suppose, for example, the case in which the information processing apparatus 10 has a faster communication link to a particular controlled apparatus than any of the controller apparatuses. In this case, the management server 100 is advantageous over the controller apparatuses because of its shorter time of communication with that controlled apparatus. For an enhanced efficiency of processing, it is therefore a better choice to use the information processing apparatus 10 as a controller apparatus, rather than transferring the control to other controller apparatuses.

The information processing apparatus 10 is, for example, a computer having a processor and a memory. The above-described data collection unit 12, selection unit 13, and requesting unit 14 may be implemented as part of the functions of the processor in the information processing apparatus 10. Specific processing steps executed by the data collection unit 12, selection unit 13, and requesting unit 14 are encoded in the form of computer programs. The processor executes these programs to provide the functions of the information processing apparatus 10. The foregoing storage unit 11, on the other hand, may be implemented as part of the memory in the information processing apparatus 10.

It is also noted that the lines interconnecting functional blocks in FIG. 1 represent some of their communication paths. The person skilled in the art would appreciate that there may be other communication paths in actual implementations.

### (B) Second Embodiment

Cloud computing is widely used today, and the second embodiment discussed below provides a solution for operations management of an ICT system in this cloud age. The conventional operations management methods use a management server to manage a set of servers connected to a single network or deployed in a single data center. In other words, the conventional methods assume a moderately-sized system of servers.

ICT systems in the cloud age are, however, made up of various environments depending on their purposes, such as public cloud systems, private cloud systems, and on-premises computing systems. With the trend of globalization, data centers deploy their managed servers across the world. Constant effort has also been made to unify the management functions and enhance the efficiency of overall system operations. These technological trends result in a growing number of managed servers per system, which could exceed the capacity that a single management server can handle. An overwhelming load of operations management makes it difficult for the management server to ensure the quality of processing at every managed server.

One solution for the difficulties discussed above is that the management server delegates a part of its operations management tasks of an automated flow to a plurality of execution servers. This solution may, however, not always work well with a cloud computing environment in which a large number of networks are involved to connect servers located at dispersed places. The tasks of operations management are executed in an automated way by manipulating managed servers on the basis of workflow definitions. The management servers respond to such manipulations, but their responsiveness may vary with their respective network distances, as well as depending on the performance of intervening networks, which could spoil the stability of operations management services. For this reason, the above-noted solution of partial delegation of management tasks, when implemented, has to take into consideration the physical distance of each execution server from managed servers.

More specifically, a workflow is made up of a plurality of tasks (individual units of processing operations), and each of these tasks manipulates one of various managed servers scattered in different sites. While it is possible to distribute the entire workflow to execution servers, some of the execution servers could consume a long time in manipulating assigned managed servers if their communication links to the managed servers perform poorly. For example, collecting log files from each managed server is one of the manipulations performed as part of a workflow. Execution servers may work together to execute log file collection, but the conventional way of distributed processing based on the load condition of CPU and memory resources would not suffice for this type of manipulation because its performance heavily depends on the bandwidth of communication links.

In view of the above, the second embodiment is configured to determine which servers to execute each particular processing operation for manipulating managed servers, with a total consideration of network distances between the servers, including: distance between the management server and each managed server, distance between the management server and each execution server, and distances between execution servers and managed servers.

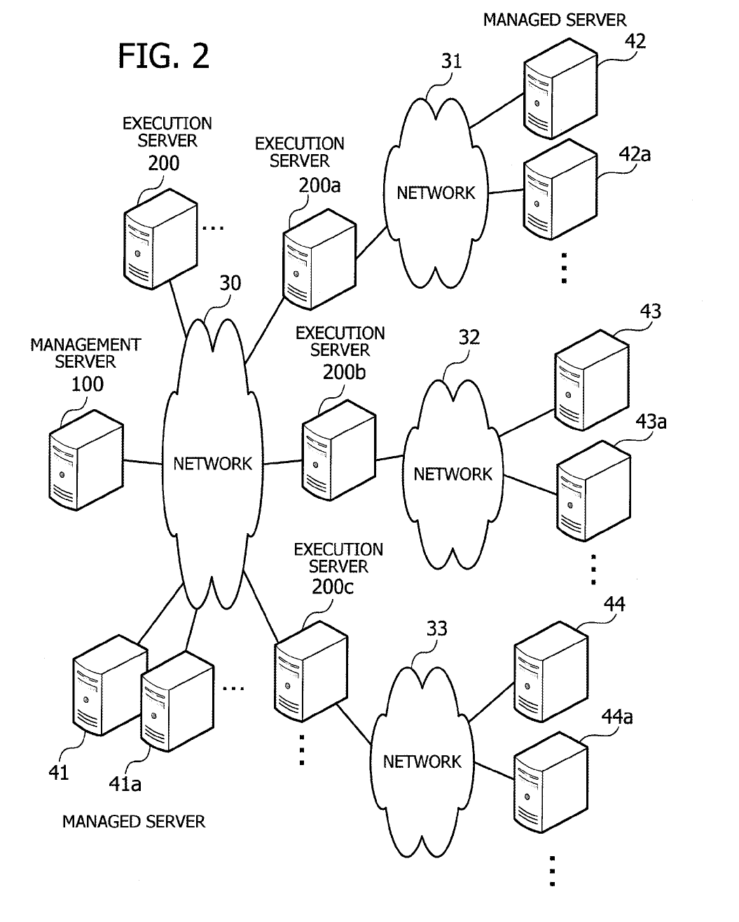

FIG. 2 illustrates an exemplary system configuration according to the second embodiment The illustrated system includes a management server 100, which is linked to four execution servers 200, 200a, 200b, 200c, . . . and managed servers 41, 41a, . . . via a network 30. One execution server 200a is linked to managed servers 42, 42a, via another network 31. Another execution server 200b is linked to managed servers 43, 43a, via yet another network 32. Yet another execution server 200c is linked to managed servers 44, 44a, . . . via still another network 33.

The management server 100 is a computer configured to control a process of operations management based on automated flows. Automated flows are pieces of software each representing a sequence of operations in workflow form. Every single unit of operation in an automated flow is expressed as a node, and the operations of these nodes may be executed by different servers. The following description will use the term “process definition” to refer to a data structure defining an automated flow. The following description will also use the term “manipulation component” to refer to a software program for implementing an operation corresponding to a specific node.

The management server 100 determines which servers to assign for the nodes in an automated flow so as to efficiently execute the automated flow as a whole. Possible servers for this assignment of node operations include the management server 100 itself and execution servers 200, 200a, 200b, 200c, and so on.

The execution servers 200, 200a, 200b, 200c, are computers configured to execute operations of the nodes that the management server 100 specifies from among those in a given automated flow. The execution servers 200, 200a, 200b, 200c, remotely manipulate managed servers via network links in accordance with programs corresponding to the specified nodes. The managed servers 41, 41a, . . . , 42, 42a, . . . , 43, 43a, . . . , 44, 44a, are devices under the management of an automated flow.

In operation of the system of FIG. 2, the management server 100 parses a process definition to identify which managed servers are to be manipulated and controls the execution of the defined workflow by assigning appropriate servers that are close to the managed servers in terms of network distance, taking into consideration the transmission rates of their links to the managed servers. The management server 100 may also sort the nodes in an automated flow into groups so as to execute operations on a group basis while avoiding long-distance communication as much as possible.

It is noted that the management server 100 is an example of the information processing apparatus 10 discussed in FIG. 1. The execution servers 200, 200a, 200b, 200c, are an example of the controller apparatuses 3 to 5 discussed in FIG. 1. Also, the managed servers 41, 41a, . . . , 42, 42a, . . . , 43, 43a, . . . , 44, 44a, . . . are an example of the controlled apparatuses 6 to 8 discussed in FIG. 1. It is further noted that manipulating managed servers in the second embodiment is an example of controlling controlled apparatuses in the first embodiment.

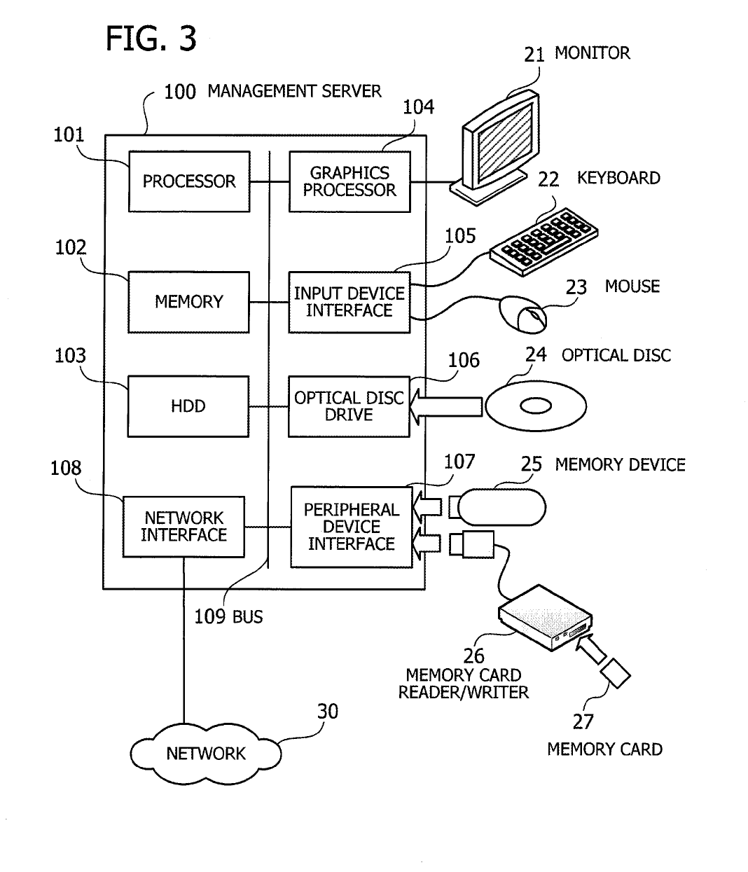

FIG. 3 illustrates an exemplary hardware configuration of a management server. The illustrated management server 100 has a processor 101 to control its entire operation. The processor 101 is connected to a memory 102 and other various devices and interfaces on a bus 109. The processor 101 may be a single processing device or a multiprocessor system including two or more processing devices. For example, the processor 101 may be a central processing unit (CPU), micro processing unit (MPU), or digital signal processor (DSP). It is also possible to implement processing functions of the processor 101 wholly or partly with an application-specific integrated circuit (ASIC), programmable logic device (PLD), or other electronic circuits, or their combinations.

The memory 102 serves as a primary storage device of the management server 100. Specifically, the memory 102 is used to temporarily store at least some of the operating system (OS) programs and application programs that the processor 101 executes, in addition to other various data objects that it manipulates at runtime. The memory 102 may be formed from, for example, random access memory (RAM) devices or other volatile semiconductor memory devices.

Other devices on the bus 109 include a hard disk drive (HDD) 103, a graphics processor 104, an input device interface 105, an optical disc drive 106, a peripheral device interface 107, and a network interface 108.

The HDD 103 writes and reads data magnetically on its internal platters. The HDD 103 serves as a secondary storage device in the management server 100 to store program and data files of the operating system and applications. Flash memory and other non-volatile semiconductor memory devices may also be used for the purpose of secondary storage.

The graphics processor 104, coupled to a monitor 21, produces video images in accordance with drawing commands from the processor 101 and displays them on a screen of the monitor 21. The monitor 21 may be, for example, a cathode ray tube (CRT) display or a liquid crystal display.

The input device interface 105 is connected to input devices such as a keyboard 22 and a mouse 23 and supplies signals from those devices to the processor 101. The mouse 23 is a pointing device, which may be replaced with other kind of pointing devices such as touchscreen, tablet, touchpad, and trackball.

The optical disc drive 106 reads out data encoded on an optical disc 24, by using laser light. The optical disc 24 is a portable data storage medium, the data recorded on which can be read as a reflection of light or the lack of the same. The optical disc 24 may be a digital versatile disc (DVD), DVD-RAM, compact disc read-only memory (CD-ROM), CD-Recordable (CD-R), or CD-Rewritable (CD-RW), for example.

The peripheral device interface 107 is a communication interface used to connect peripheral devices to the management server 100. For example, the peripheral device interface 107 may be used to connect a memory device 25 and a memory card reader/writer 26. The memory device 25 is a data storage medium having a capability to communicate with the peripheral device interface 107. The memory card reader/writer 26 is an adapter used to write data to or read data from a memory card 27, which is a data storage medium in the form of a small card. The network interface 108 is linked to a network 30 so as to exchange data with other computers (not illustrated).

The processing functions of the second embodiment may be realized with the above hardware structure of FIG. 3. The same hardware platform may also be used to implement the execution servers 200, 200a, 200b, 200c, . . . and managed servers 41, 41a, . . . , 42, 42a, . . . , 43, 43a, . . . , 44, 44a, . . . similarly to the management server 100. This is also true to the foregoing information processing apparatus 10 of the first embodiment.

The management server 100 and execution servers 200, 200a, 200b, 200c, . . . provide various processing functions of the second embodiment by executing programs stored in computer-readable storage media. These processing functions are encoded in the form of computer programs, which may be stored in a variety of media. For example, the management server 100 may store program files in its HDD 103. The processor 101 loads the memory 102 with at least part of the programs stored in the HDD 103 and executes the programs on the memory 102. Such programs for the management server 100 may be stored in an optical disc 24, memory device 25, memory card 27, or other kinds of portable storage media. Programs stored in a portable storage medium are installed in the HDD 103 under the control of the processor 101, so that they are ready to execute upon request. It may also be possible for the processor 101 to execute program codes read out of a portable storage medium, without installing them in its local storage devices.

The following description will now explain each functional component implemented in the management server 100 and execution servers 200, 200a, 200b, 200c, and so on.

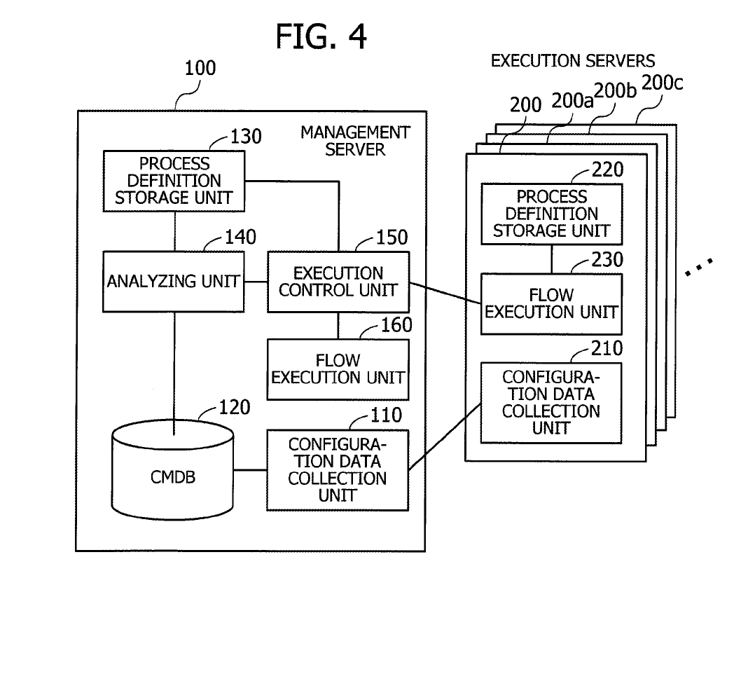

FIG. 4 is a functional block diagram of a management server and execution servers. The illustrated management server 100 includes a configuration data collection unit 110, a configuration management database (CMDB) 120, a process definition storage unit 130, an analyzing unit 140, an execution control unit 150, and a flow execution unit 160.

The configuration data collection unit 110 communicates with execution servers or managed servers to collect information about their total system configuration, which is referred to as “configuration data.” The configuration data collection unit 110 stores this configuration data in a CMDB 120. The CMDB 120 is a database configured to manage system configuration data. For example, this CMDB 120 may be implemented as part of storage space of the memory 102 or HDD 103.

The process definition storage unit 130 stores process definitions. For example, this process definition storage unit 130 may be implemented as part of, for example, storage space of the memory 102 or HDD 103. The analyzing unit 140 parses a process definition to determine how to organize the nodes into groups and produces grouping information that describes such groups of nodes. The analyzing unit 140 then calculates communication performance of each server that may be able to execute operations of a particular node group. The execution control unit 150 determines which servers to use for execution of operations, based on the data of communication performance calculated by the analyzing unit 140. The flow execution unit 160 executes the operation of a specified node in an automated flow when so commanded by the execution control unit 150.

The execution server 200 illustrated in FIG. 4 includes a configuration data collection unit 210, a process definition storage unit 220, and a flow execution unit 230. These functional elements in the execution server 200 are provided similarly in other execution servers 200a, 200b, 200c, and so on.

The configuration data collection unit 210 collects configuration data of managed servers that can be reached from the execution server 200 and sends the collected data to the management server 100. The process definition storage unit 220 stores process definitions. For example, this process definition storage unit 220 may be implemented as part of, for example, storage space of a memory 102 or HDD 103 in the execution server 200. The flow execution unit 230 executes the operation of a specified node in an automated flow when so commanded by the execution control unit 150 in the management server 100.

As seen in FIG. 4, the management server 100 has its own flow execution unit 160 similarly to the execution servers 200, 200a, 200b, 200c, . . . , so that some of node operations in an automated flow can be executed by the management server 100. In other words, the management server 100 may also function as an execution server.

It is noted that the process definition storage unit 130 is an example of the storage unit 11 discussed in FIG. 1. The configuration data collection unit 110 is an example of the data collection unit 12 discussed in FIG. 1. The analyzing unit 140 is an example of the selection unit 13 discussed in FIG. 1. The execution control unit 150 is an example of the requesting unit 14 discussed in FIG. 1. It is also noted that the lines interconnecting functional blocks in FIG. 4 represent some of their communication paths. The person skilled in the art would appreciate that there may be other communication paths in actual implementations.

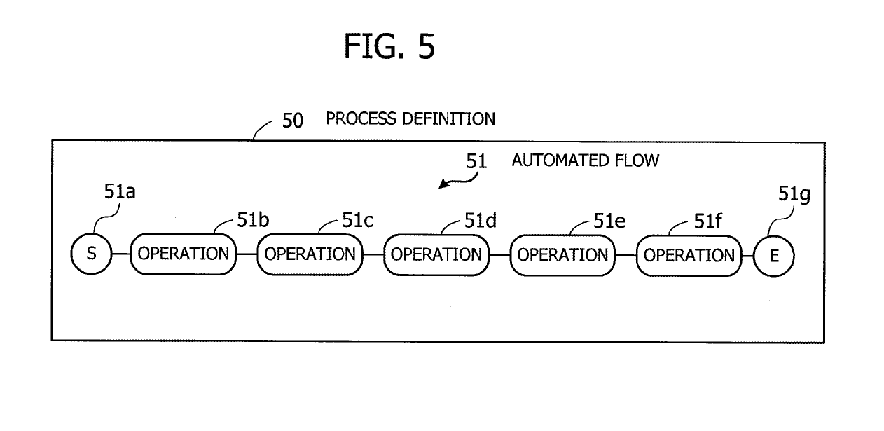

The following section will now provide more details of process definitions. FIG. 5 illustrates an example of a process definition. The illustrated process definition 50 defines an automated flow 51, which is a workflow formed from a series of operations to be performed as part of operations management activities of the system. The illustrated automated flow 51 includes a plurality of nodes 51a to 51g, beginning at a start node 51a and terminating at an end node 51g. Connected between the start node 51a and end node 51g are operation nodes 51b to 51f, each representing a single unit of processing operation. These nodes 51b to 51f are each associated with a specific program describing what operation to perform, as well as with the identifier of a specific managed server that is to be manipulated in that operation. Some operations do not manipulate any managed servers. The nodes of such operations have no associated identifiers of managed servers.

The execution of the above automated flow 51 starts from its start node 51a, and each defined processing operation is executed along the connection path of nodes until the end node 51g is reached.

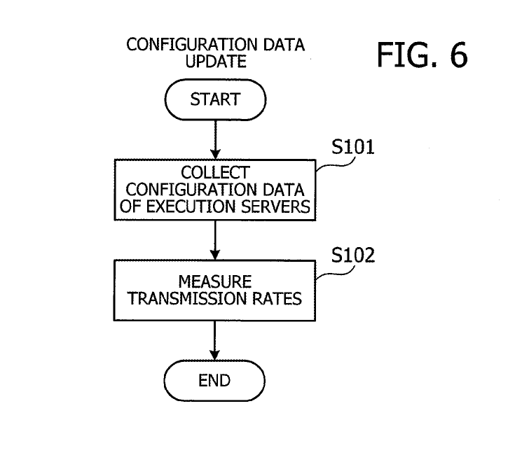

The configuration data stored in the CMDB 120 is updated before starting execution of such an automated flow in process definitions. FIG. 6 is a flowchart illustrating an exemplary process of updating configuration data.

(Step S101) The configuration data collection unit 110 in the management server 100 collects configuration data of execution servers. For example, the configuration data collection unit 110 communicates with the configuration data collection unit in each execution server to collect configuration data of managed servers. The collected configuration data is entered to the CMDB 120 in the management server 100. The collected data includes, for example, the host names and Internet Protocol (IP) addresses of managed servers and execution servers. Also included is information about the transmission rates (B/s) between each combination of execution and managed servers.

For example, the configuration data collection unit 110 in an execution server measures its transmission rates by sending some appropriate commands (e.g., ping) to each managed server on the same network where the execution server resides. The configuration data collection unit 110 similarly measures transmission rates with remote managed servers that are reached via two or more networks. When ping commands are used for the measurement, the following process enables calculation of transmission rates:

<Step-1> The execution server issues a ping command addressed to a particular managed server as in:
ping (IP address of managed server)−1 65000 where the parameter value “65000” specifies the size of data attached to the command. The receiving server returns a response to this ping command, which permits the sending execution server to measure the elapsed time from command transmission to response reception.

<Step-2> The execution server repeats the ping command of Step-1 five times and calculates their average response time.

<Step-3> The execution server performs the following calculation, thus obtaining a transmission rate value.

65000×2/(average response time)=transmission rate (B/s)

(Step S102) The configuration data collection unit 110 measures transmission rates of communication links between the management server 100 and each managed server. For example, the configuration data collection unit 110 starts measuring the transmission rates (B/s) of communication links between the management server 100 and managed servers, upon entry of the above-described configuration data to the CMDB 120 at step S101. The configuration data collection unit 110 uses the same measurement method discussed above for the execution servers. The resulting measurement data is entered to the CMDB 120. More specifically, the configuration data collection unit 110 populates the CMDB 120 with records of transmission rates, each of which corresponds to a particular managed server and indicates the transmission rates measured from its communication with the management server 100 and each execution server. In each such record, the configuration data collection unit 110 sorts the list of management server and execution servers in descending order of transmission rates.

The configuration data collection unit 110 further measures transmission rates between the management server 100 and each execution server and enters the records into the CMDB 120.

The above-described updating of configuration data may be performed at regular intervals (e.g., once every day) depending on the system's operation schedules. This regular update keeps the CMDB 120 in the latest state, with an enhanced accuracy of information content. Alternatively, the CMDB 120 may be updated at the time of addition, removal, or other changes in the managed servers and network devices.

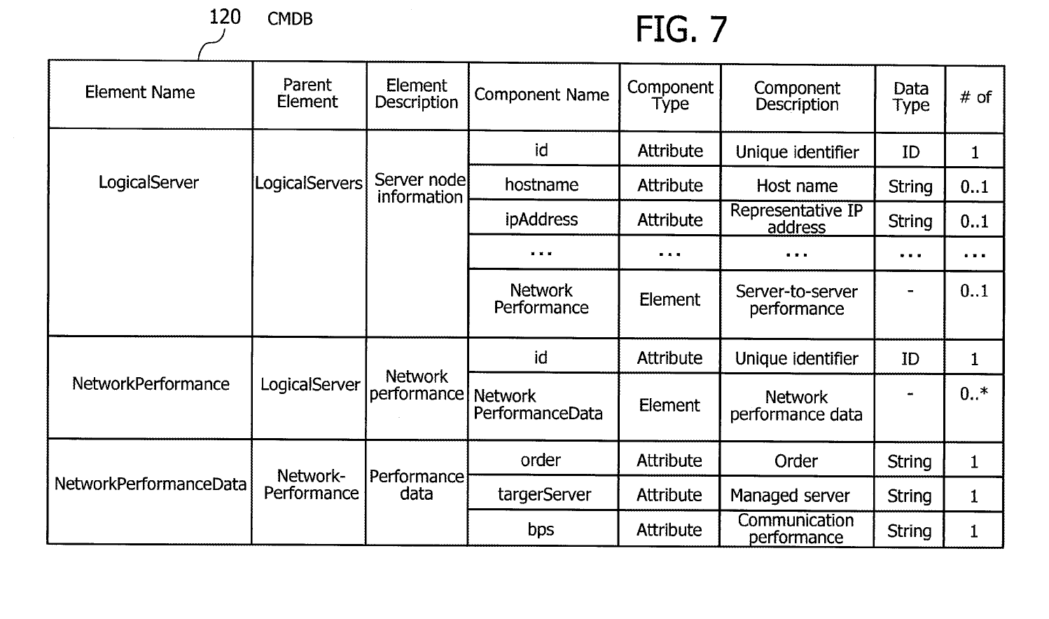

The data structure of the CMDB 120 will now be described below. FIG. 7 illustrates an exemplary data structure of the CMDB 120. Specifically, the CMDB 120 contains the following values: “Element Name,” “Parent Element,” “Element Description,” “Component Name,” “Component Type,” “Component Description,” “Data Type,” and “# of.”

Element Name represents the name of a stored element (referred to herein as “the element in question”). Parent Element indicates the name of a parent element of the element in question. When this parent element name is different from the element name noted above, the element in question is a child element of the named parent element. A child element has information about its parent element. When the parent element name is identical with the child element name, then it means that the element in question is at the highest level.

Element Description is a character string that explains the element in question. For example, the description may read: “Server node information,” “Network performance,” and “Performance data.”

Component Name indicates the name of information (component) contained in the element in question. One element may include a plurality of components, and those components may include child elements.

Component Type indicates the type of a component. For example, the component type field takes a value of “Attribute” meaning that the component is a piece of attribute information on a pertinent element, or “Element” meaning that the component is a child element.

Component Description contains a character string that describes the component. The description may read, for example, “Unique identifier,” “Host name,” “Representative IP address,” or “Server-to-server performance.”

Data Type indicates the type of component data. For example, this data type field takes a value of “String” to indicate that the data in question is a character string.

Symbol # denotes “the number” and the value of “# of” in the CMDB 120 indicates how many pieces of data are registered in the component.

The CMDB 120 stores data of components constituting each managed element in the way described above. This CMDB 120 permits the management server 100 to obtain, for example, the host name, IP address, communication performance, and other items of a specific execution server. Such data is stored in the format of, for example, the Extensible Markup Language (XML).

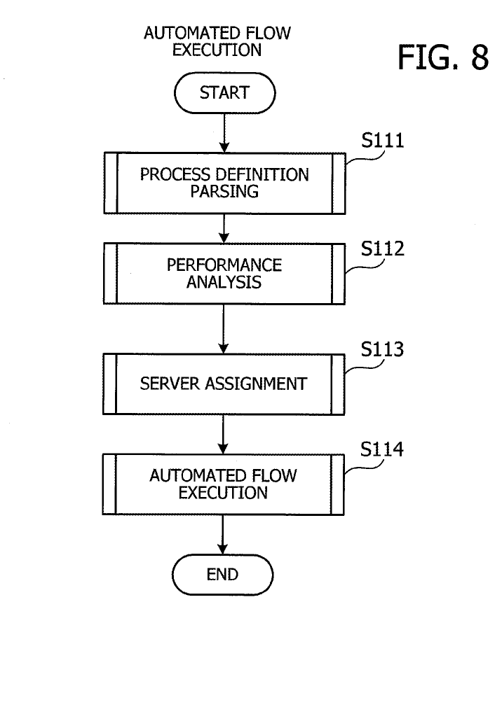

The next section will now describe how the management server 100 executes an automated flow. FIG. 8 is a flowchart illustrating an exemplary process of automated flow execution.

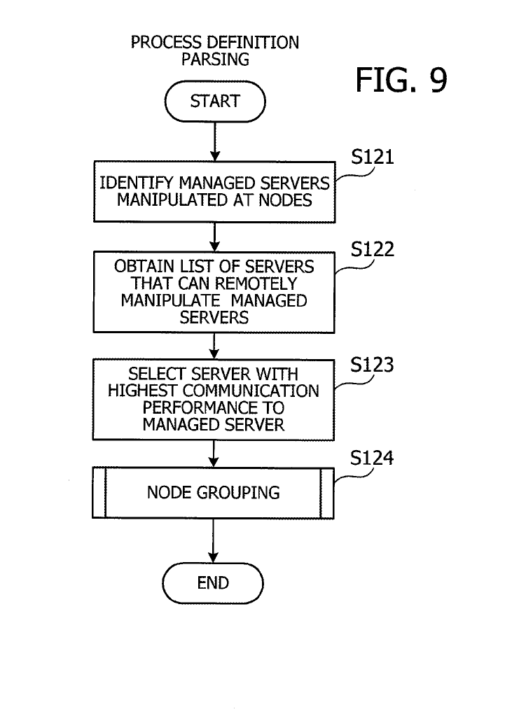

(Step S111) The analyzing unit 140 parses a process definition. For example, the analyzing unit 140 consults the process definition storage unit 130 to retrieve a process definition for execution of an automated flow. The analyzing unit 140 then sorts the nodes of the automated flow into groups, depending on the content of the retrieved process definition, as well as based on the data of server-to-server transmission rates which is stored in the CMDB 120. The details of this parsing step will be described later with reference to FIG. 9.

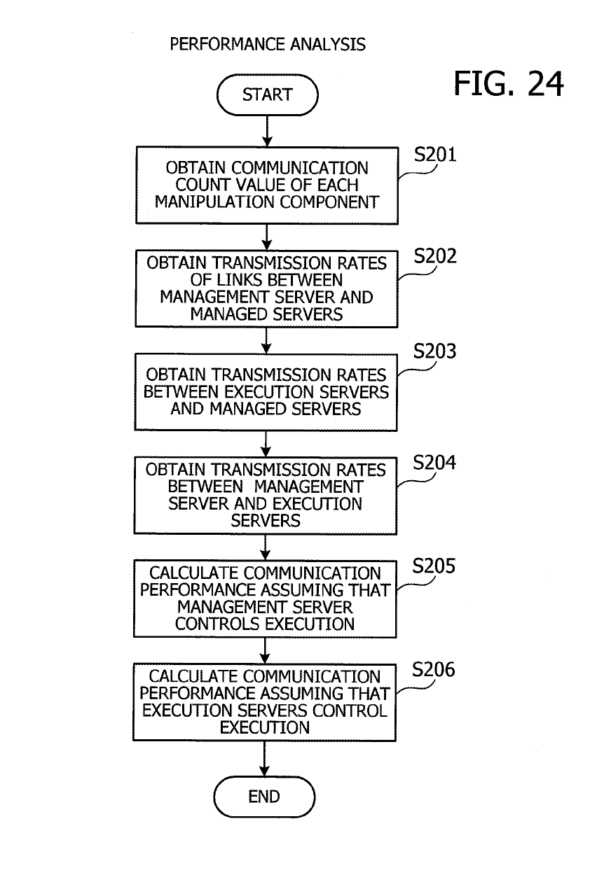

(Step S112) The analyzing unit 140 conducts a performance analysis, assuming that the load of node operations in the automated flow is distributed across multiple servers. Details of this performance analysis will be described later with reference to FIG. 24.

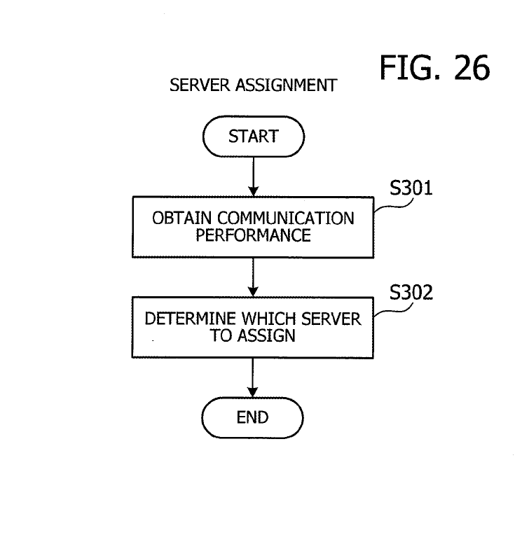

(Step S113) The execution control unit 150 determines which server (e.g., management server or execution server) to assign for each node in the automated flow so as to attain a higher performance. The execution control units 150 is configured to select a single server to execute operations of multiple nodes when these nodes belong to the same group. Details of this server assignment will be described later with reference to FIG. 26.

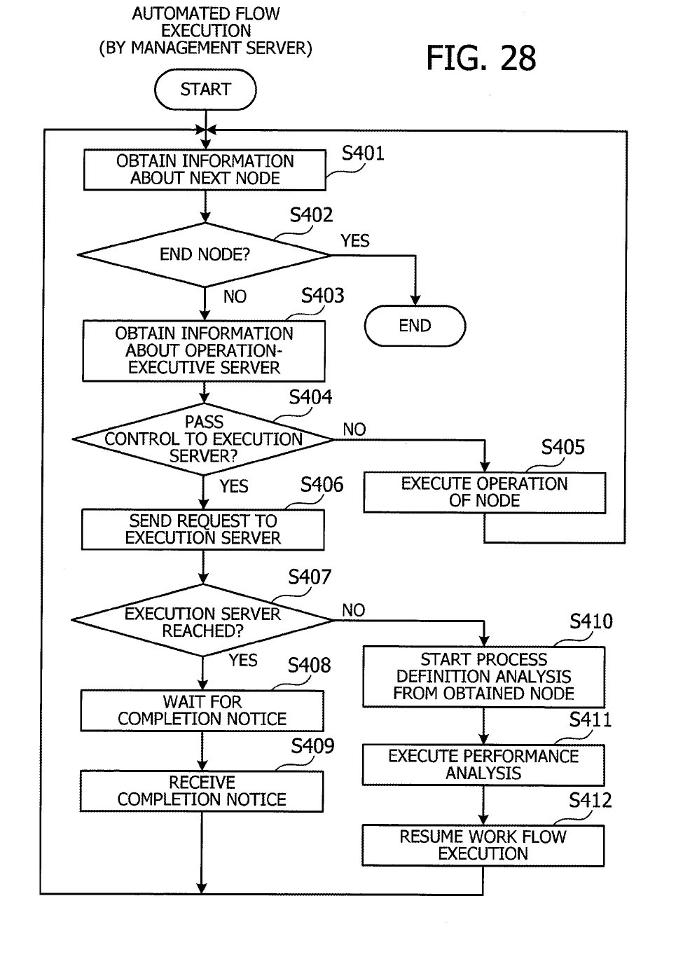

(Step S114) The execution control unit 150 executes operations defined in the automated flow. Details of this execution will be described later with reference to FIG. 28.

The above description of FIG. 8 has outlined how an automated flow is executed. The following sections will now provide details of each step seen in FIG. 8.

(a) Process Definition Parsing

FIG. 9 is a flowchart illustrating an exemplary process of process definition analysis.

(Step S121) The analyzing unit 140 obtains a process definition from the process definition storage unit 130 and identifies which managed server is to be manipulated at each node. For example, process definitions may include an IP address or a host name associated with each node, which indicates a managed server to be manipulated at the node. The analyzing unit 140 uses such IP addresses or host names of nodes to determine which managed server to manipulate at each node.

(Step S122) The analyzing unit 140 obtains a list of execution servers that are capable of communicating with the managed server identified above. For example, the analyzing unit 140 searches the CMDB 120 for managed servers by using the obtained IP addresses or host names (see S121) as search keys. When pertinent managed servers are found, the analyzing unit 140 then retrieves their configuration data from the CMDB 120, which includes a list of execution servers capable of remotely manipulating those managed servers, as well as information about transmission rates of links between each execution server and managed servers.

(Step S123) The above step S121 has identified execution servers as being capable of remotely manipulating pertinent managed servers. The analyzing unit 140 now selects one of those execution servers that has the highest communication performance with a particular managed server to be manipulated and associates the selected execution server with that managed server. For example, the analyzing unit 140 compares different active execution servers in the list obtained at step S122 in terms of the transmission rates of their links to a particular managed server. The analyzing unit 140 then singles out an execution server with the highest transmission rate for the managed server and registers their combination in a node-vs-server management table.

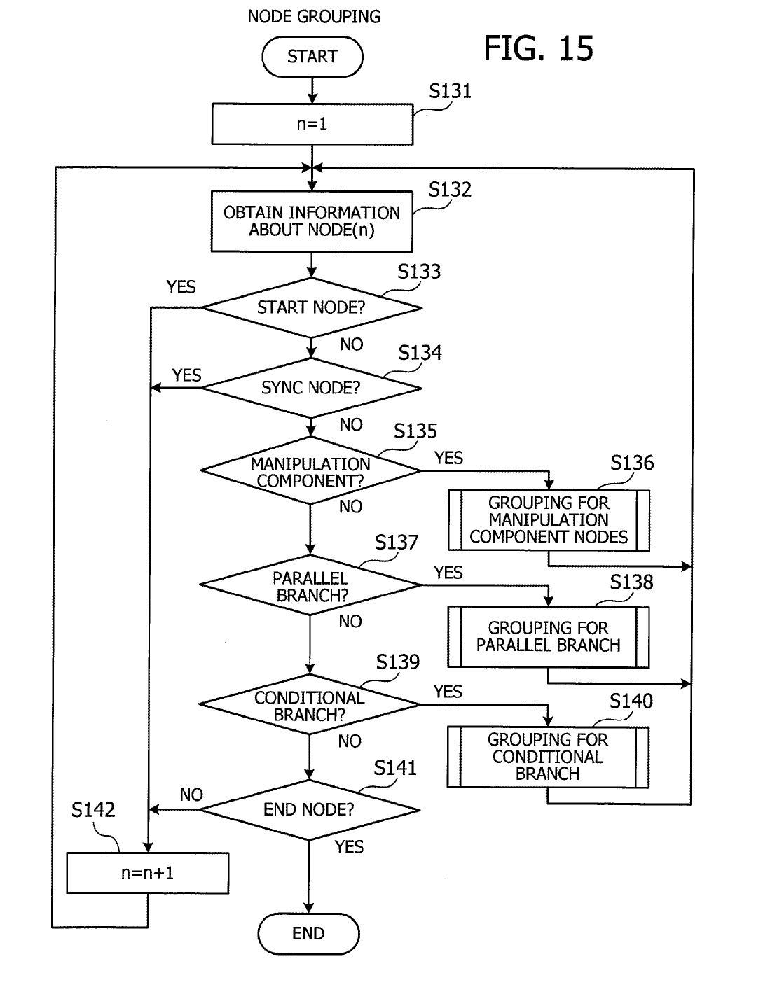

(Step S124) The analyzing unit 140 sorts the nodes into groups. Details of this node grouping will be described later with reference to FIG. 15.

The above steps permit the analyzing unit 140 to parse a process definition. Step S123 in this course produces a node-vs-server management table discussed below.

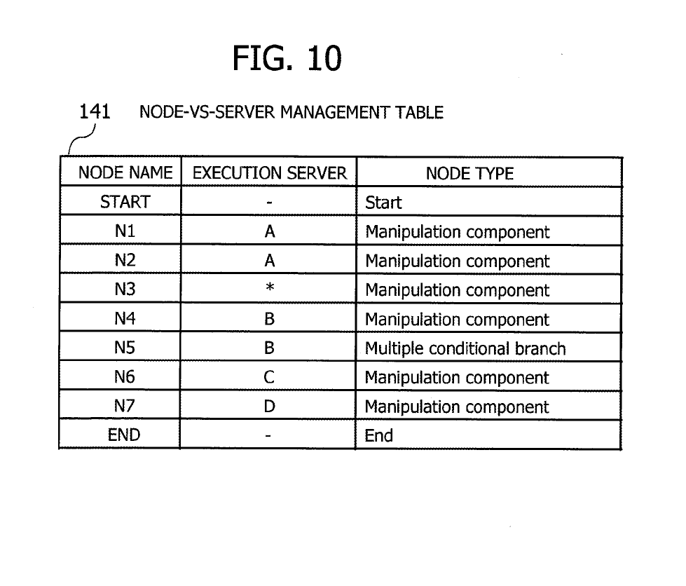

FIG. 10 exemplifies a node-vs-server management table. The illustrated node-vs-server management table 141 is formed from the following data fields: “Node Name,” “Execution Server,” and “Node Type.”

The node name field of each record contains the name of a node included in an automated flow, and the execution server field contains the name of an execution server supposed to execute the operation of that node. The nodes in an automated flow may include those that manipulate managed servers and those that do not. Included in the latter group is, for example, a node that processes data given as a result of some other operation. Since any servers can execute such nodes, the execution server field of these nodes is marked with a special symbol (e.g., asterisk in FIG. 10) indicating no particular restrictions in server assignment.

The node type field describes the type of a node, which may be, for example, “Start,” “End,” “Manipulation component,” and “Multiple conditional branch.” Start node is a node at which the automated flow starts. End node is a node at which the automated flow terminates. Manipulation component is a node that causes a server to execute a certain processing operation. Multiple conditional branch is a manipulation component that tests conditions for choosing a subsequent branch.

The above node-vs-server management table 141 is used in node grouping. Think of, for example, an environment where servers are dispersed over the network as in a cloud computing system. Since it is desirable in such an environment to reduce the frequency of server communication as much as possible, the analyzing unit 140 sorts the nodes into groups so that a group of nodes can be executed by a single server. Processing operations of the nodes are then assigned to execution servers on a group basis, so that the managing node communicates with execution servers less frequently.

For example, process definitions include information about the order of execution of nodes in an automated flow. The analyzing unit 140 examines this information to extract nodes that can be executed successively by a single server, and puts them all into a single group. The following description provides a detailed process of node grouping, assuming that the nodes are numbered in the order of their execution, as in “node (n)” denoting the nth node and “node (n+1)” denoting the (n+1)th node, where n is an integer greater than zero.

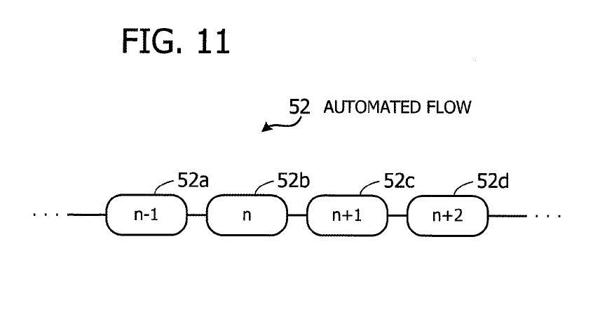

FIG. 11 illustrates a first example of an automated flow. The illustrated automated flow 52 of FIG. 11 is an example of successive manipulation components. Specifically, the automated flow 52 is formed from a plurality of nodes 52a, 42b, 52c, and 52d connected in series, the leftmost node being the first to execute.

To discover which nodes are groupable in this automated flow 52, node (n) is compared with node (n+1) in terms of their associated execution servers. When the two nodes' execution servers coincide with each other, or when one of the two nodes does not care about selection of its execution server, node (n) and node (n+1) are put into a group. The group is then associated with the common server of node (n) and node (n+1).

For example, the aforementioned group management table may have an existing record of group for node (n). In that case, node (n+1) is added to the same record as a new member of the group. When that is not the case, a new group is produced from node (n) and node (n+1) and added to the group management table.

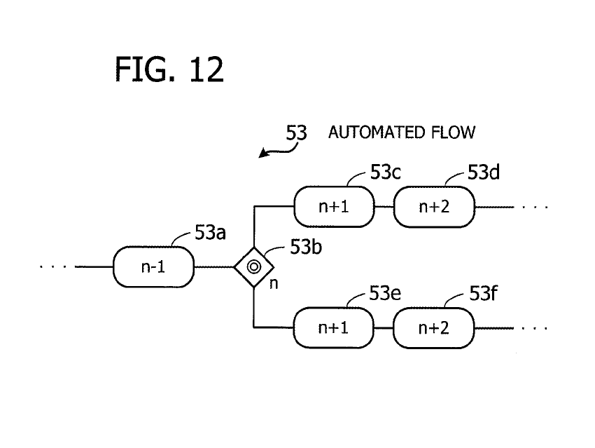

FIG. 12 illustrates a second example of an automated flow. The illustrated automated flow 53 of FIG. 12 has a node 53a before it reaches a parallel branch node 53b. At the parallel branch node 53b, the automated flow 53 is then bifurcated into two routes. Each route includes a plurality of nodes representing a series of processing operations. Referring to the example of FIG. 12, one route executes nodes 53c and 53d, and the other route executes different nodes 53e and 53f. These two routes are supposed to be executed in parallel.

When grouping nodes in this automated flow 53, the analyzing unit 140 consults information about node (n+1) to determine to which group node (n) belongs. Referring to the example of FIG. 12, there are two nodes 53c and 53e that are regarded as node (n+1). With the presence of two routes, the analyzing unit 140 traces each individual route by applying the same logic discussed above to form a group from successive manipulation components. For example, the analyzing unit 140 forms a group from nodes 53c and 53d when the latter node 53d is found to share the same associated execution server with the former node 53c. Similarly, the analyzing unit 140 forms another group from nodes 53e and 53f when the latter node 53f is found to share the same associated execution server with the former node 53e.

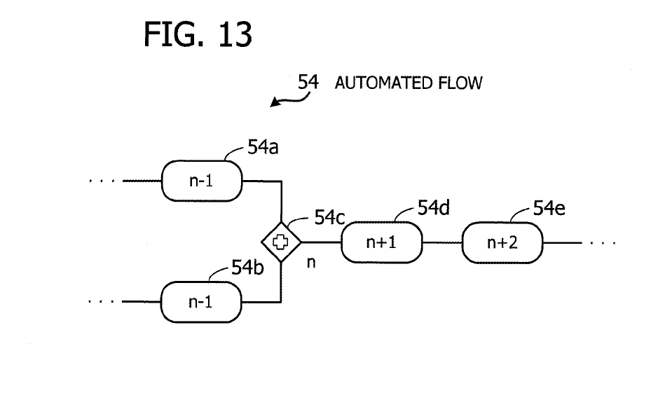

FIG. 13 illustrates a third example of an automated flow. The illustrated automated flow 54 of FIG. 13 has a synchronization node 54c that synchronizes the operations of two nodes 54a and 54b on two parallel routes with each other, before the process advances to subsequent nodes 54d and 54e. The terms “synchronization” and “synchronize” refer to the act of waiting until all ongoing parallel operations are finished, before starting the next operation.

When the synchronization node 54c is encountered as node (n) in the course of node grouping, the analyzing unit 140 does not put the synchronization node 54c to any groups for the following reasons. The synchronization node 54c is preceded by a plurality of nodes (n−1), i.e., nodes 54a and 54b in the present example of FIG. 13. If the synchronization node 54c belongs to a different group from those of the preceding nodes 54a and 54b, the execution servers associated with the nodes 54a and 54b will send their respective execution completion notices to the management server 100 upon completion the assigned operations. Then it is reasonable to execute the synchronization node 54c by the management server 100 itself, because the management server 100 would be able to determine whether all parallel operations on the multiple routes are finished.

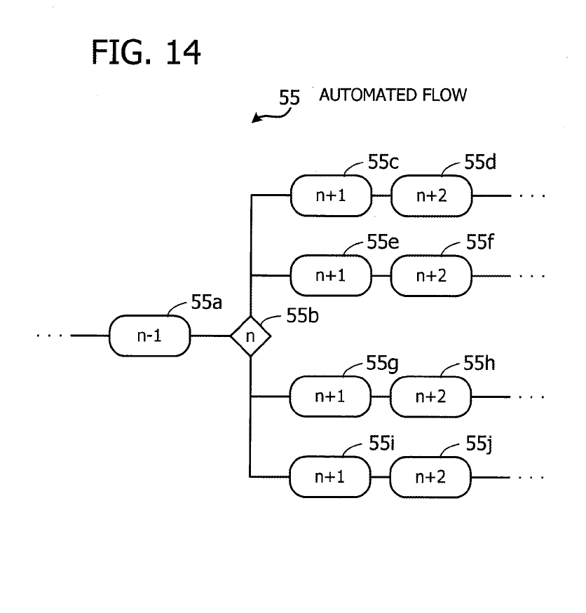

FIG. 14 illustrates a fourth example of an automated flow. The illustrated automated flow 55 of FIG. 14 includes a conditional branch node 55b placed next to a node 55a, so that the process branches into a plurality of routes. The first route executes nodes 55c and 55d, and the second route executes nodes 55e and 55f. The third route executes nodes 55g and 55h, and the fourth route executes nodes 55i and 55j. The conditional branch node 55b selects one of these four routes so as to execute the nodes only on the selected route.

Which branch route to take in the illustrated automated flow 55 depends on the result of an operation at the preceding node 55a. Taking this into consideration, the analyzing unit 140 performs the following things when grouping the nodes in the automated flow 55.

The analyzing unit 140 first obtains information about node (n−1) and nodes (n+1) from the node-vs-server management table 141. It is noted here that there are a plurality of nodes (n+1) to which the process flow may branch from node (n). When the group management table has an existing group including node (n−1) as a member, the analyzing unit 140 obtains information about the execution server associated with that existing group and compares the obtained information with information about each execution server associated with nodes (n+1). When a match is found with one of those nodes (n+1), the analyzing unit 140 puts node (n) and that node (n+1) to the existing group of node (n−1). When no match is found, the analyzing unit 140 abandons the current grouping attempt and proceeds to each node (n+1) to seek new groups for them.

When, on the other hand, the group management table includes no existing groups for node (n−1), the analyzing unit 140 obtains information about the execution server associated with node (n−1) and compares the obtained information with information about each execution server associated with nodes (n+1). When a match is found with one of those nodes (n+1), the analyzing unit 140 produces a new group from node (n−1), node (n) and that node (n+1). When no match is found, the analyzing unit 140 abandons the current grouping attempt and proceeds to each node (n+1) to seek new groups for them.

Then after the branching, the analyzing unit 140 tests each successive nodes as to whether the node in question is to be executed by the same server of its preceding node. When they are found to share the same server, the analyzing unit 140 adds the node in question to the group of the preceding node. This is similar to the foregoing case of successive manipulation components.

The above-described process of node grouping may be presented in a flowchart described below. FIG. 15 is a flowchart illustrating an exemplary process of grouping nodes in a given automated flow.

(Step S131) The analyzing unit 140 initializes a variable n to one, thus beginning the grouping process at the start node of the given automated flow.

(Step S132) The analyzing unit 140 retrieves information about node (n) from the node-vs-server management table 141.

(Step S133) The analyzing unit 140 checks the node type field value of node (n) in the retrieved information. The analyzing unit 140 now determines whether node (n) is a start node. When node (n) is found to be a start node, the process skips to step S142. Otherwise, the process advances to step S134.

(Step S134) The analyzing unit 140 also determines whether node (n) is a synchronization node. A synchronization node permits a plurality of parallel operations in different branch routes to synchronize with each other and join together into a single route of operations. When node (n) is found to be a synchronization node, the process skips to step S142. Otherwise, the process advances to step S135.

(Step S135) The analyzing unit 140 further determines whether node (n) is a manipulation component. When node (n) is found to be a manipulation component, the process proceeds to step S136. Otherwise, the process advances to step S137.

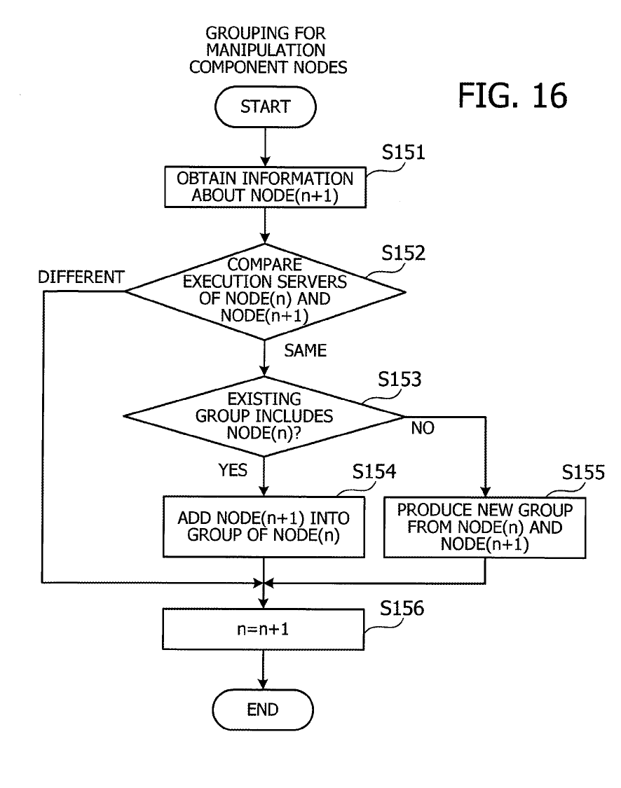

(Step S136) For the manipulation component node (n), the analyzing unit 140 calls a grouping routine for manipulation component nodes. Details of this grouping routine will be described later with reference to FIG. 16. When the control is returned, the process continues from step S132.

(Step S137) The analyzing unit 140 further determines whether node (n) is a parallel branch node. When node (n) is found to be a parallel branch node, the process proceeds to step S138. Otherwise, the process advances to step S139.

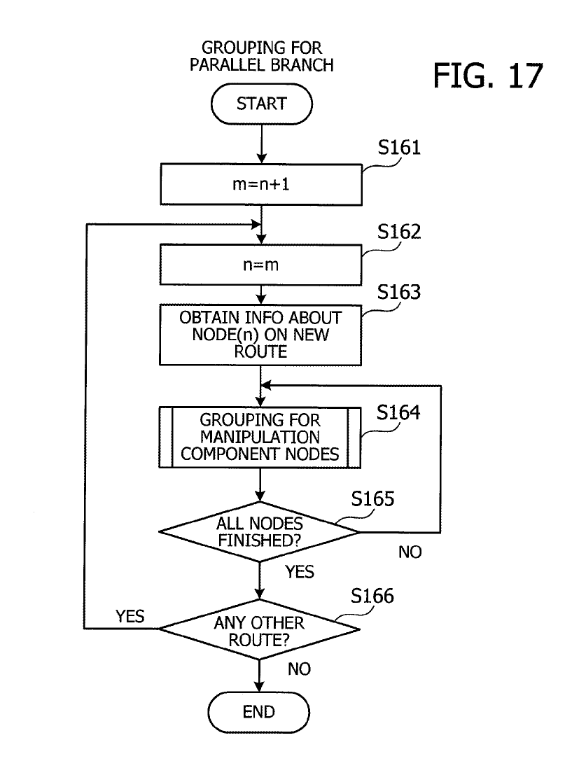

(Step S138) For the parallel branch node (n), the analyzing unit 140 calls a grouping routine for parallel branch. Details of this grouping routine will be described later with reference to FIG. 17. When the control is returned, the process continues from step S132.

(Step S139) The analyzing unit 140 further determines whether node (n) is a conditional branch node. When node (n) is found to be a conditional branch node, the process proceeds to step S140. Otherwise, the process advances to step S141.

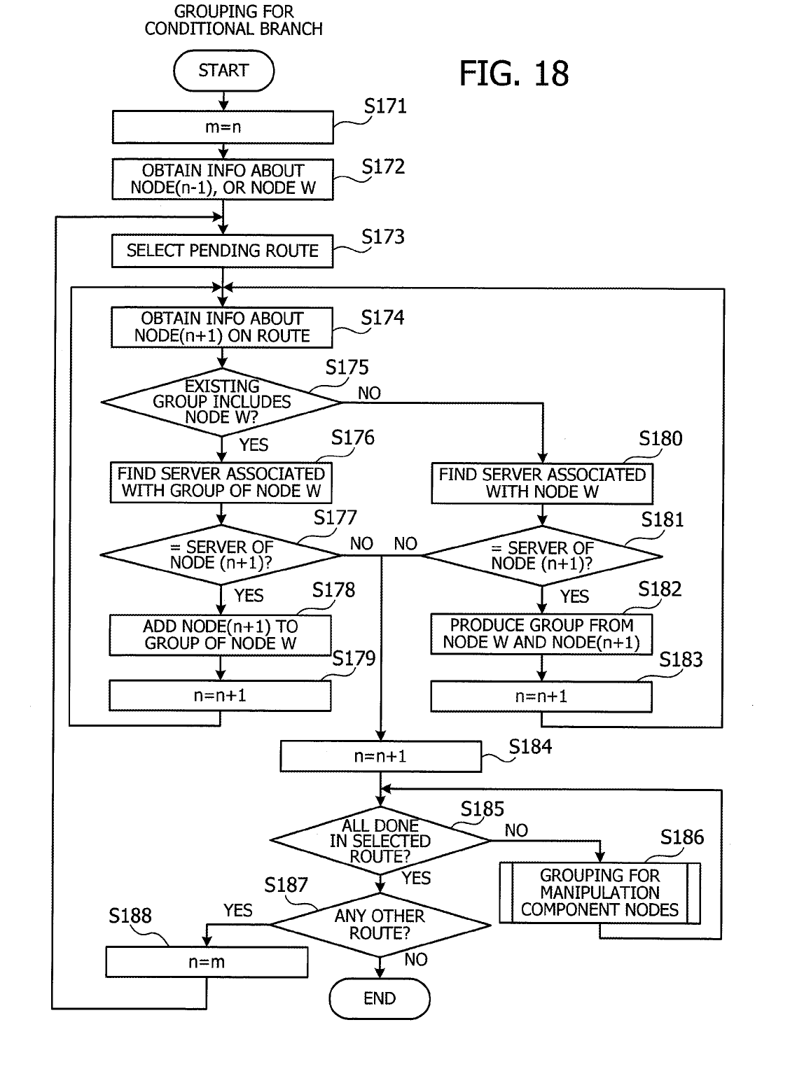

(Step S140) For the conditional branch node (n), the analyzing unit 140 calls a grouping routine for conditional branch. Details of this grouping routine will be described later with reference to FIG. 18. When the control is returned, the process continues from step S132.

(Step S141) The analyzing unit 140 further determines whether node (n) is an end node. When node (n) is found to be an end node, the grouping process of FIG. 15 is closed. Otherwise, the process goes back to step S142.

(Step S142) The analyzing unit 140 increments n by one and moves the process back to step S132 to process the next node.

The above steps permit the node grouping process to invoke appropriate routines depending on the type of nodes. The following description will provide details of each node type-specific grouping routine.

Described in the first place is a grouping routine for manipulation component nodes. FIG. 16 is a flowchart illustrating an example of a grouping routine for manipulation component nodes.

(Step S151) The analyzing unit 140 obtains information about node (n+1) from the node-vs-server management table 141.

(Step S152) The analyzing unit 140 compares node (n) with node (n+1) in terms of their associated execution servers. When these two execution servers are identical, the process advances to step S153. When they are different servers, the process skips to step S156. It is noted that when either or both of the two nodes do not care about selection of their execution servers, the analyzing unit 140 behaves as if their execution servers are identical.

(Step S153) Since the two nodes are found to share the same execution server, the analyzing unit 140 now consults the group management table to determine whether there is an existing group including node (n) as a member. When such an existing group is found, the process advances to step S154. When no such groups are found, the process proceeds to step S155.

(Step S154) The analyzing unit 140 adds node (n+1) to the group of node (n) in the group management table. The process then proceeds to step S156.

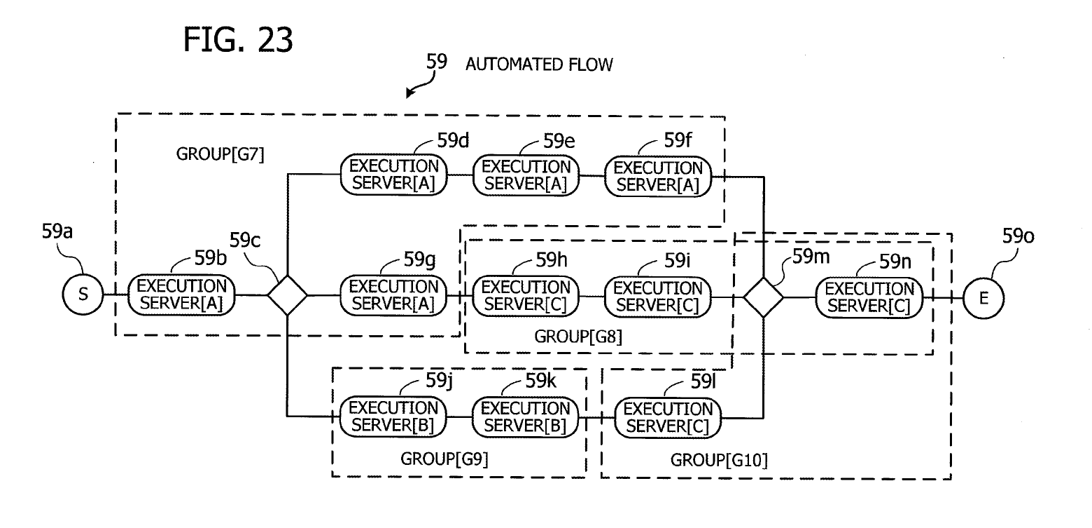

It is noted here that node (n) may belong to two or more groups in some cases. See, for example, FIG. 23, in which the illustrated automated flow includes a conditional branch node that originates a plurality of branch routes. In this case, the node following the rejoining point of these branch routes belong to multiple groups. Referring back to FIG. 16, when node (n) belongs to two or more groups, the analyzing unit 140 also adds node (n+1) to those groups at step S154.

(Step S155) The analyzing unit 140 produces a group from node (n) and node (n+1) and registers this new group with the group management table. The process then proceeds to step S156.

(Step S156) The analyzing unit 140 increments n by one and exists from the grouping routine for manipulation component nodes.

The following description will now explain another grouping routine called to handle parallel branches. FIG. 17 is a flowchart illustrating an example of a grouping routine for parallel branch.

(Step S161) The analyzing unit 140 assigns the value of n+1 to another variable m, where m is an integer greater than zero.

(Step S162) The analyzing unit 140 substitutes m for n.

(Step S163) There is a plurality of nodes (n) originating different branch routes, which are subject to the following steps. At step S163, the analyzing unit 140 selects one of these pending branch routes. For example, the analyzing unit 140 is configured to select such routes in ascending order of the number of nodes included in their parallel sections. The analyzing unit 140 consults the node-vs-server management table 141 to obtain information about node (n) in the selected route.

(Step S164) The analyzing unit 140 subjects node (n) in the selected route to a process of node grouping by calling the foregoing grouping routine for manipulation component nodes.

(Step S165) The analyzing unit 140 determines whether it has finished processing of the last node in the selected route. When the last node is done, the process advances to step S166. When there remains a pending node in the selected route, the process goes back to step S164.

(Step S166) The analyzing unit 140 determines whether there is any other parallel branch route to select. When a pending route is found, the process goes back to step S162. When there are no pending routes, the analyzing unit 140 exits from the grouping routine for parallel branch.

The following description will now explain yet another grouping routine called to handle conditional branches. FIG. 18 is a flowchart illustrating an example of a grouping routine for conditional branch.

(Step S171) The analyzing unit 140 assigns the current value of n to another variable m.

(Step S172) The analyzing unit 140 obtains information about node (n−1), i.e., the node immediately before the conditional branch node, from the node-vs-server management table 141. This node is referred to herein as “node W.”

(Step S173) There is a plurality of routes following the conditional branch node, which are subject to the following steps. At step S173, the analyzing unit 140 selects one of these pending routes. For example, the analyzing unit 140 is configured to select such routes in ascending order of the number of nodes included in them.

(Step S174) The analyzing unit 140 consults the node-vs-server management table 141 to obtain information about node (n+1) in the selected route. It is noted that the nodes concerned in this step S174 include, not only the nodes right on the selected route, but also the rejoining node (e.g., node 59m in FIG. 23) and its subsequent node (e.g., node 59n in FIG. 23). This also means that analyzing unit 140 allows, where appropriate, the rejoining node and its subsequent node to belong to two or more groups. When the selected route has no node at the position of node (n+1), the node-vs-server management table 141 returns null (no information) to the analyzing unit 140.

(Step S175) The analyzing unit 140 determine whether the group management table has an existing group including node W as its member. When such a group is found, the process advances to step S176. Otherwise, the process proceeds to step S180.

(Step S176) The analyzing unit 140 consults the group management table to retrieve information about the execution server associated with the existing group of node W.

(Step S177) The analyzing unit 140 compares the execution server associated with the group of node W with the execution server associated with node (n+1). When these two execution servers are identical, the process advances to step S178. When they are different servers, the process proceeds to step S184. It is noted that when either or both of the compared group and node (n+1) do not care about selection of their execution servers, the analyzing unit 140 behaves as if their execution servers are identical, and thus advances the process to step S178. It is further noted that the analyzing unit 140 determines that their execution servers are different when step S174 has failed to obtain information about node (n+1).

(Step S178) The analyzing unit 140 adds node (n+1) to the group of node W as a new member.

(Step S179) The analyzing unit 140 increments n by one and moves the process back to step S174.

(Step S180) Since there is no existing group that includes node W, the analyzing unit 140 consults the group management table to retrieve information about the execution server associated with node W.

(Step S181) The analyzing unit 140 compares the execution server associated with node W with the execution server associated with node (n+1). When these two execution servers are identical, the process advances to step S182. When they are different servers, the process proceeds to step S184. It is noted that when either or both of the two nodes do not care about selection of their execution server, the analyzing unit 140 behaves as if their execution servers are identical. It is further noted that the analyzing unit 140 determines that they are different servers when step S174 has failed to obtain information about node (n+1).

(Step S182) The analyzing unit 140 produces a group from node W and node (n+1).

(Step S183) The analyzing unit 140 increments n by one and moves the process back to step S174.

(Step S184) This step has been reached because the execution server associated with node W or the group including node W is found to be different from the one associated with node (n+1). The analyzing unit 140 increments n by one and moves the process back to step S185.

(Step S185) The analyzing unit 140 determines whether it has finished processing as to the selected route. For example, the analyzing unit 140 determines whether node (n) is the last node of the selected route. If this test returns true, it means that all processing of the route has been finished. When this is the case, the process advances to step S187. Otherwise, the process proceeds to step S186.

(Step S186) The analyzing unit 140 subjects the nodes in the selected route to a grouping routine for manipulation component nodes (see FIG. 16). The process then returns to step S185.

(Step S187) The analyzing unit 140 determines whether it has finished all routes derived from the conditional branch node. When all routes are done, the analyzing unit 140 exits from the current grouping routine. When there is a pending route, the process proceeds to step S188.

(Step S188) The analyzing unit 140 substitutes m for n, thus resetting node (n) to the conditional branch node. The process then returns to step S173.

The above-described grouping routines permit the analyzing unit 140 to sort the nodes in an automated flow into groups. The results of these routines are compiled into a group management table and saved in the memory 102 or the like.

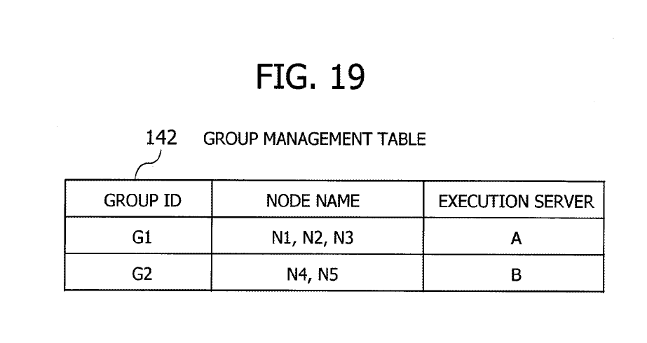

FIG. 19 illustrates an exemplary data structure of a group management table. The illustrated group management table 142 is formed from the following data fields: “Group ID,” “Node Name,” and “Execution Server.”

The group ID field contains a group ID for uniquely identifying a particular group, and the node name field enumerates the nodes constituting the group. The execution server field contains the name of an execution server that is associated with these member nodes.

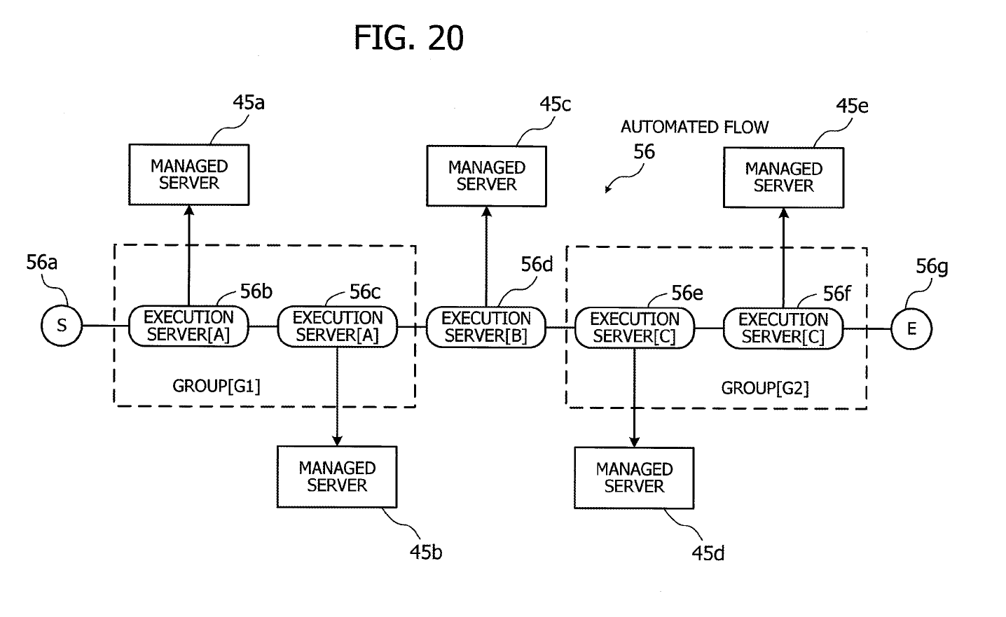

Referring now to FIGS. 20 to 23, the following description will provide several examples of grouping results. Seen in the symbol of each operation node in FIGS. 20 to 23 is the name of an execution server assigned thereto.

FIG. 20 illustrates a first example of grouping. The illustrated automated flow 56 of FIG. 20 includes five operation nodes 56b to 56f between its start node 56a and end node 56g, which are supposed to be executed one by one in the order that they are connected. The first node 56b of the five defines an operation of manipulating a managed server 45a and is assigned an execution server [A] to execute the defined operation. The second node 56c defines an operation of manipulating a managed server 45b and is also assigned the execution server [A] to execute the defined operation. The third node 56d defines an operation of manipulating a managed server 45c and is assigned an execution server [B] to execute the defined operation. The fourth node 56e defines an operation of manipulating a managed server 45d and is assigned an execution server [C] to execute the defined operation. The fifth node 56f defines an operation of manipulating a managed server 45e and is also assigned the execution server [C] to execute the defined operation.

The analyzing unit 140 in this case calls the foregoing grouping routine for manipulation component nodes (see FIG. 16). That is, the analyzing unit 140 finds a succession of nodes that are executed by the same server and puts these nodes into a single group. Referring to the example of FIG. 20, two nodes 56b and 56c form a group [G1], and another two nodes 56e and 56f form another group [G2].

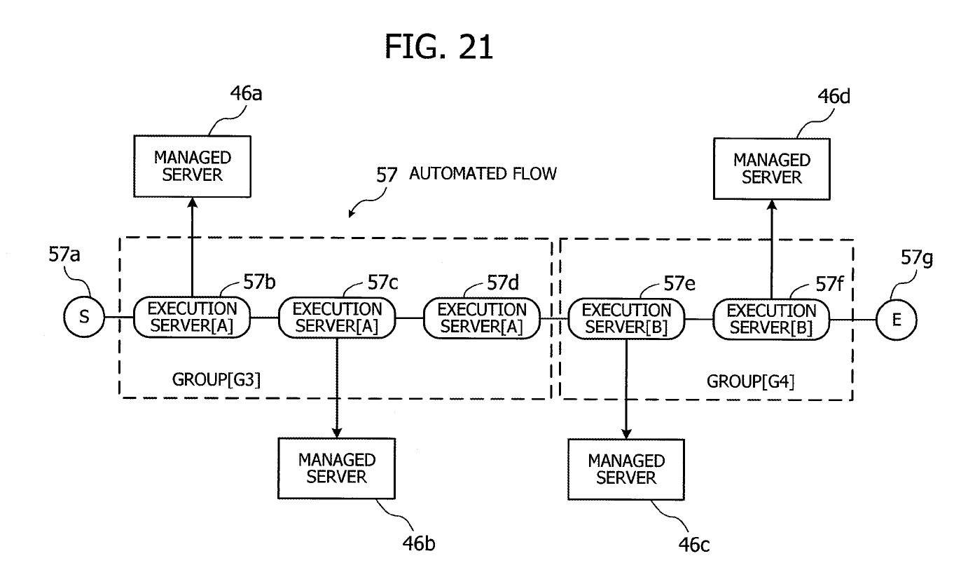

FIG. 21 illustrates a second example of grouping. The illustrated automated flow 57 of FIG. 21 includes five operation nodes 57b to 57f between its start node 57a and end node 57g, which are supposed to be executed one by one in the order that they are connected. The first node 57b of the five defines an operation of manipulating a managed server 46a and is assigned an execution server [A] to execute the defined operation. The second node 57c defines an operation of manipulating a managed server 46b and is also assigned the execution server [A] to execute the defined operation. The third node 57d defines an operation that does not include any manipulation of managed servers and is also assigned the execution server [A] to execute the defined operation. The third node 57e defines an operation of manipulating a managed server 46c and is assigned an execution server [B] to execute the defined operation. The fifth node 57f defines an operation of manipulating a managed server 46d and is also assigned the execution server [B] to execute the defined operation.

The analyzing unit 140 calls the foregoing grouping routine for manipulation component nodes (see FIG. 16). The analyzing unit 140 puts a node to a group of its immediately preceding node when the former node has no managed servers to manipulate. Referring to the example of FIG. 21, three nodes 57b to 57d form a group [G3], and two nodes 57e and 57f form another group [G4]. The third node 57d defines an operation that does not manipulate any managed servers and is thus included in group [G3] together with its preceding node 57c in the example of FIG. 21. As an alternative, it may also be possible for the other group [G4] to include the third node 57d together with its succeeding node 57e.

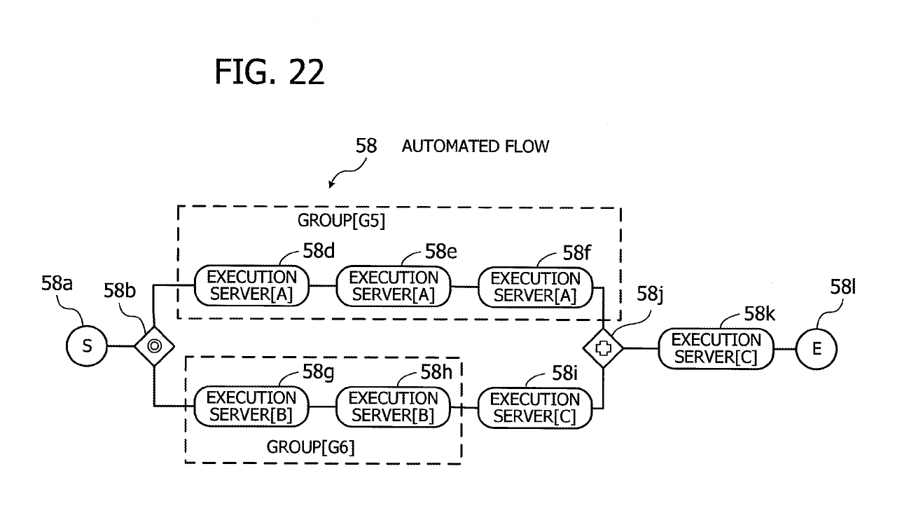

FIG. 22 illustrates a third example of grouping. This third example is directed to an automated flow 58 containing a parallel branch node. Specifically, the illustrated automated flow 58 has a parallel branch node 58b next to its start node 58a. The automated flow 58 branches at the parallel branch node 58b into two parallel routes, one containing nodes 58d to 58f and the other containing nodes 58g to 58i. The operations of these two routes are executed in parallel. The two routes then rejoin at a synchronization node 58j before reaching the last node 58k. The last node 58k is followed by an end node 58l. While FIG. 22 does not explicitly depict managed servers corresponding to the nodes, all the operation nodes 58d to 58i and 58k are supposed to manipulate some managed servers.

Operations of three nodes 58d to 58f are executed by an execution server [A]. Operations of two nodes 58g and 58h are executed by another execution server [B]. Operation of two nodes 58i and 58k are executed by yet another execution server “C”.

Since the automated flow 58 includes two parallel branch routes in the middle of its execution, the analyzing unit 140 calls the process of FIG. 18 to sort the nodes into groups. That is, the analyzing unit 140 forms groups in each individual branch route, whereas no grouping processing takes place across the branching point or rejoining point. Referring to the example of FIG. 22, the operations of nodes 58d to 58f on one branch are executed by an execution server [A]. Accordingly, these nodes 58 to 58f form one group [G5]. Likewise, the operations of nodes 58g and 58h are both executed by an execution server [B]. Accordingly, these nodes 58g and 58h form another group [G6]. The remaining nodes 58i and 58k are executed in succession by the same execution server [C], but the analyzing unit 140 does not put these nodes 58i and 58k into a group because of the presence of a synchronization node 58j between them.

FIG. 23 illustrates a fourth example of grouping. This fourth example is directed to an automated flow 59 containing a conditional branch node. Specifically, the illustrated automated flow 59 includes a manipulation component node 59b next to its start node 59a, which is then followed by a conditional branch node 59c. The conditional branch node 59c leads to three routes, one of which is executed depending on the result of a test at the conditional branch node 59c. The first route executes a series of operations at nodes 59d to 59f. The second route executes another series of operations at nodes 59g to 59i. The third route executes yet another series of operations at nodes 59j to 59l. These routes rejoin at a node 59m before another operation is executed at its subsequent node 59n. The node 59n is followed by an end node 59o. While FIG. 23 does not explicitly depict managed servers corresponding to the nodes, all the operation nodes 59b, 59d to 59l, and 59n are supposed to manipulate some managed servers.

Operations of three nodes 59b and 59d to 59g are executed by an execution server [A]. Operations of two nodes 59j and 59k are executed by another execution server [B]. Operations of four nodes 59h, 59i, 59l and 59n are executed by yet another execution server [C].

The above automated flow 59 makes a conditional branch in the middle of its execution, and which route the automated flow 59 takes is not known until the branch node is reached at runtime. In view of this, the analyzing unit 140 compares the execution server of the pre-branch node 59b with the execution server of each post-branch node 59d, 59g, and 59j. If a match is found, the analyzing unit 140 produces a group from the pertinent nodes.

Referring to the example of FIG. 23, the first route includes nodes 59d to 59f, all of which match with the pre-branch node 59b in terms of their corresponding execution servers. Accordingly, the analyzing unit 140 combines the node 59b with nodes 59d to 59f to form one group [G7]. Regarding the second route, its topmost node 59g matches with the pre-branch node 59b in terms of their corresponding execution servers, but the next node 59h does not. Accordingly, the analyzing unit 140 extracts the node 59g from among the second-route nodes 59g to 59i and puts it into the group [G7] of the pre-branch node 59b. The third route begins with a node 59j, whose execution server is different from that of the pre-branch node 59b. This means that the none of the third-route nodes 59j to 59i would be a member of group [G7]. The conditional branch node 59c, on the other hand, may be put into the same group [G7] of the pre-branch node 59b.

Referring again to the second route, two nodes 59h and 59i share the same execution server and thus form their own group [G8]. Similarly, two nodes 59j and 59k on the third route form their own group [G9] since they share the same execution server.

The node 59n next to the rejoining point of the above three routes is assigned an execution server [C], which matches with the execution server of the last node 59i of the second route. Accordingly, the analyzing unit 140 adds this node 59n to the same group [G8] of the last node 59i of the second route. The execution server of the node 59n also matches with that of the last node 59l on the third route. Accordingly, the analyzing unit 140 further produces a group [G10] from these two nodes 59l and 59n. It is noted that the node 59n belongs to two groups [G8] and [G10]. The rejoining node 59m may be included in, for example, the group of its subsequent node 59n.

The resultant groups in the example of FIG. 23 eliminate the need for the execution server [A] to return its processing result to the management server 100 in the case where the process makes its way to either the node 59d or the node 59g. This feature contributes to a reduced frequency of server-to-server communication.

As can be seen from the above description, the proposed management server 100 is configured to produce a group from nodes that are assigned the same server for their execution. The execution servers work more efficiently because of their less frequent communication with the management server 100.

(b) Performance Analysis

This section provides the details of performance analysis. FIG. 24 is a flowchart illustrating an exemplary process of performance analysis.

(Step S201) The analyzing unit 140 obtains a communication count value with respect to each manipulation component in a specific automated flow. The analyzing unit 140 assigns the obtained count value to a variable i.

For example, the analyzing unit 140 has a communication count previously defined for each type of manipulation components to indicate the number of communication events between the management server 100 and a managed server pertinent to the processing operation of that manipulation component. The definitions are previously stored in, for example, the memory 102 or HDD 103 of the management server 100. The analyzing unit 140 identifies the type of a manipulation component in question and retrieves its corresponding communication count value from the memory 102 or the like. The user is allowed to set up the communication counts specific to manipulation component types. For example, the user may create his or her own manipulation components and define their corresponding communication counts.

(Step S202) The analyzing unit 140 consults the CMDB 120 to obtain data of transmission rates at which the management server 100 communicates with managed servers to manipulate them in an automated flow. These transmission rates, Sa, are used when the management server 100 is assigned to managed servers for their manipulation.

(Step S203) The analyzing unit 140 consults the CMDB 120 to obtain data of transmission rates at which execution servers communicate with managed servers to manipulate them in an automated flow. These transmission rates, Sb, are used when execution servers are assigned to managed servers for their manipulation.

(Step S204) The analyzing unit 140 further obtains data from the CMDB 120 as to the transmission rates Sc of links between the management server and execution servers.

(Step S205) For each node and each group, the analyzing unit 140 calculates communication performance in the case where the management server 100 directly manipulates managed servers. This calculation applies to all managed servers to be manipulated in the automated flow. More specifically, the following formulas give the communication performance:

(i) Performance of Solitary Node

Solitary nodes are nodes that are not included in any groups. Let X represent the length of processing packets of a manipulation component corresponding to such a node. The communication performance of this solitary node in question is then calculated with the following formula (1):

X/Sa×i (1)

where Sa represents the transmission rate of a communication link between the management server and the managed server to be manipulated at the node in question.

(ii) Performance of Node Group

Let k, an integer greater than zero, be the number of nodes in a group, and {X1, X2, . . . , Xk} represent the lengths of processing packets of manipulation components corresponding to k nodes in the group in question. The communication performance of the group is calculated with the following formula (2):

{X1/Sa×i}+{X2/Sa×i}+ . . . +{Xk/Sa×i} (2)

where Sa represents the transmission rates of communication links between the management server and the managed servers to be manipulated in the group of nodes in question.

(Step S206) The analyzing unit 140 calculates communication performance in the case where execution servers manipulate managed servers after receiving the control to execute the automated flow. This calculation is performed for every combination of the management server and a managed server. More specifically, the following formulas give the communication performance:

(i) Performance of Solitary Node

Let Y be the length of a flow execution request packet to an execution server associated with a node, and Z be the length of a flow completion packet from the execution server back to the management server. The communication performance of the node is then calculated with the following formula (3):

Y/Sc+X/Sb×i+Z/Sc (3)

where Sb represents the transmission rate of a communication link between the execution server associated with the node in question and the managed server to be manipulated at that node, and Sc represents the transmission rate of a communication link between the management server and the noted execution server.

(ii) Performance of Node Group

The communication performance of a group is calculated with the following formula (4):

{Y/Sc}+{X1/Sb×i}+{X2/Sb×i}+ . . . +{Xn/Sb×i}+{Z/Sc} (4)

where Sb represents the transmission rates of communication links between the execution server associated with the group in question and managed servers to be manipulated in that group, and Sc represents the transmission rate of a communication link between the management server and the noted execution server.

The nodes in a group are executed by a single execution server to which the management server passes its control. This means that the management server has only to send one flow execution request to the execution server and receive one flow completion notice from the same, in spite of multiple operations executed during the flow.

The above-described calculation of communication performance uses packet length parameters that have previously been measured and recorded. For example, packet lengths may be measured from the following packets: processing packets specific to each manipulation component, flow execution request packets to execution servers, and flow completion packets from execution servers to management server. It is also possible to update existing records of packet lengths with new values measured during the course of manipulations performed by the system. This dynamic in-service update of packet lengths improves the accuracy of performance analysis.

The above description has explained how the communication performance is calculated. Referring to formulas (1) to (4) discussed above, smaller output values of the formulas suggest higher communication performance. The calculated values of communication performance are recorded in the memory 102 in the form of, for example, a communication performance management table.

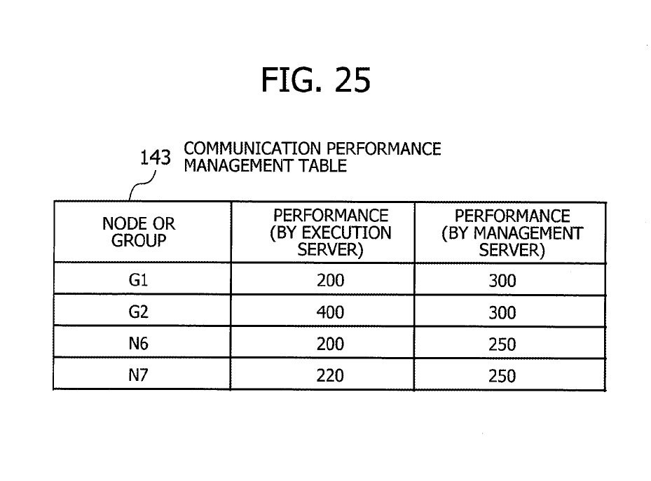

FIG. 25 illustrates an exemplary data structure of a communication performance management table. The illustrated communication performance management table 143 is formed from the following data fields: “Node or Group,” “Performance (By Execution Server),” and “Performance (By Management Server).” The node or group field contains the name of a node or a group. The performance (by execution server) field indicates the communication performance in the case where managed servers are manipulated by execution servers. The performance (by management server) field indicates the communication performance in the case where managed servers are manipulated by the management server 100.

(c) Server Assignment

With the communication performance calculated by the analyzing unit 140, the execution control unit 150 determines which server to assign for execution of each node or group of nodes in the automated flow of interest.

FIG. 26 is a flowchart illustrating an exemplary process of execution server assignment.

(Step S301) The execution control unit 150 consults the communication performance management table 143 to obtain data of communication performance.

(Step S302) The execution control unit 150 selects either the management server 100 or execution server, whichever exhibits a higher communication performance. The execution control unit 150 makes this selection for each node or group listed in the communication performance management table 143 and assigns the selected servers to their pertinent nodes or groups. The assigned servers will execute the processing operations of nodes or groups and are thus referred to herein as the “operation-assigned servers.”

For example, the execution control unit 150 compares the management server 100 with the execution server associated with the node or group in question in terms of their communication performance. When the execution server has a higher communication performance (or smaller calculated value), the execution control unit 150 assigns the execution server to the node or group as its operation-assigned server. When the management server 100 has a higher communication performance (or smaller calculated value), the execution control unit 150 assigns the management server 100 to the node or group as its operation-assigned server. The execution control unit 150 then records this determination result in the memory 102 in the form of, for example, an operation-assigned server management table.

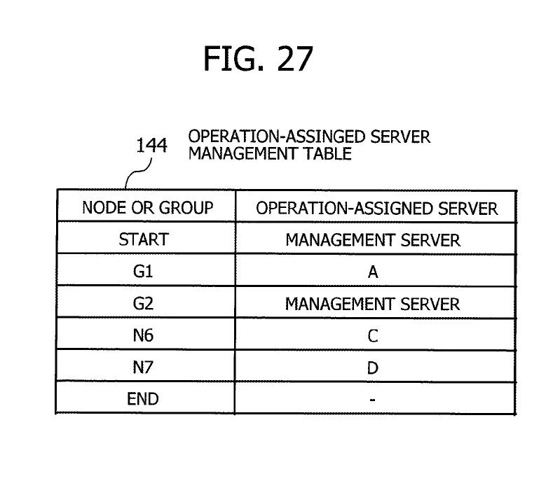

FIG. 27 illustrates an exemplary data structure of an operation-assigned server management table. The illustrated operation-assigned server management table 144 is formed from two data fields named “Node or Group” and “Operation-assigned Server.” The node-or-group field contains either the name of a solitary node in the automated flow to be executed or the name of a group of nodes in the same. The operation-assigned server field contains the name of a server that has been assigned to the node or group in question for execution of its defined operations. This server may be either a management server or an execution server. In the latter case, the execution server's identifier is registered in the operation-assigned server field.

(d) Execution of Automated Flow

This section describes a process of executing an automated flow. The execution of an automated flow may actually be either or both of: (1) execution by the execution control unit 150 in the management server 100, and (2) execution by execution servers to which the management server 100 has passed the control.

FIG. 28 is a flowchart illustrating an exemplary process of automated flow execution.

(Step S401) The execution control unit 150 consults the process definition storage unit 130 to obtain information about the next node it executes in the automated flow.

(Step S402) The execution control unit 150 determines whether the node in question is an end node. When it is an end node, the current process of automated flow execution is closed. Otherwise, the process advances to step S403.

(Step S403) The execution control unit 150 consults the operation-assigned server management table 144 and group management table 142 to obtain information about the operation-assigned server assigned to the node in question. The act of this step actually depends on whether the node in question is a solitary node or a member node of a group. In the former case, the execution control unit 150 consults the operation-assigned server management table 144 to see the execution server or management server specified in the operation-assigned server field relevant to the node. The latter case (i.e., when the next node belongs to a group) is known to the execution control unit 150 through the group management table 142. That is, the execution control unit 150 identifies a group containing the node and obtains its group ID from the group management table 142. The execution control unit 150 uses the group ID to look up its associated operation-assigned server (management server or execution server) in the operation-assigned server management table 144.

(Step S404) The execution control unit 150 currently owns the control in the process of automated flow execution. The execution control unit 150 now determines whether to pass this control to an execution server. For example, the execution control unit 150 determines to pass the control to an execution server when that server is assigned to the node as its operation-assigned server. The process thus advances to step S406. When, on the other hand, the management server 100 is assigned as the operation-assigned server, the execution control unit 150 holds the control and advances the process to step S405.

(Step S405) Inside the management server 100, the execution control unit 150 requests the flow execution unit 160 to execute operation corresponding to the node. In the case where the node belongs to a group, the execution control unit 150 causes the flow execution unit 160 to execute all nodes in that group. The flow execution unit 160 executes such node operations as instructed by the execution control unit 150. The process then returns to step S401.

(Step S406) The execution control unit 150 requests the assigned execution server to execute the operation of the current node or group. For example, the execution control unit 150 inserts an extra node next to the current node or group of nodes in the automated flow, so that the execution server will return the control to the management server 100 when the requested operation is finished. The execution control unit 150 requests the execution server to execute from the current node until the added control node is reached.

(Step S407) The execution control unit 150 determines whether the processing at step S406 has successfully communicated with the execution server. When the communication is successful, the process advances to step S408. When the execution control unit 150 is unable to reach the execution server, the process branches to step S410.

(Step S408) The execution control unit 150 waits for a completion notice from the execution server.

(Step S409) The execution control unit 150 receives a completion notice from the execution server. The process then goes back to step S401.

(Step S410) Unable to reach the execution server, the execution control unit 150 executes the foregoing process definition analysis of FIG. 9 from the node obtained at step S401. The execution server at issue is treated here as being shutdown. The process definition analysis rebuilds the groups based on the latest information on active execution servers.

(Step S411) The execution control unit 150 executes the foregoing performance analysis of FIG. 24. The execution server failed at step S406 is excluded from the subject of this performance analysis.

(Step S412) The execution control unit 150 executes the foregoing server assignment of FIG. 26 and then brings the process back to step S401 with the same node previously obtained at the last execution of step S401.

The above-described steps permit the proposed system to execute operations of each node in a given automated flow by using efficient servers. The management server 100 delegates some node operations to execution servers when they are expected to perform more efficiently, and the assigned execution servers execute requested operations accordingly.

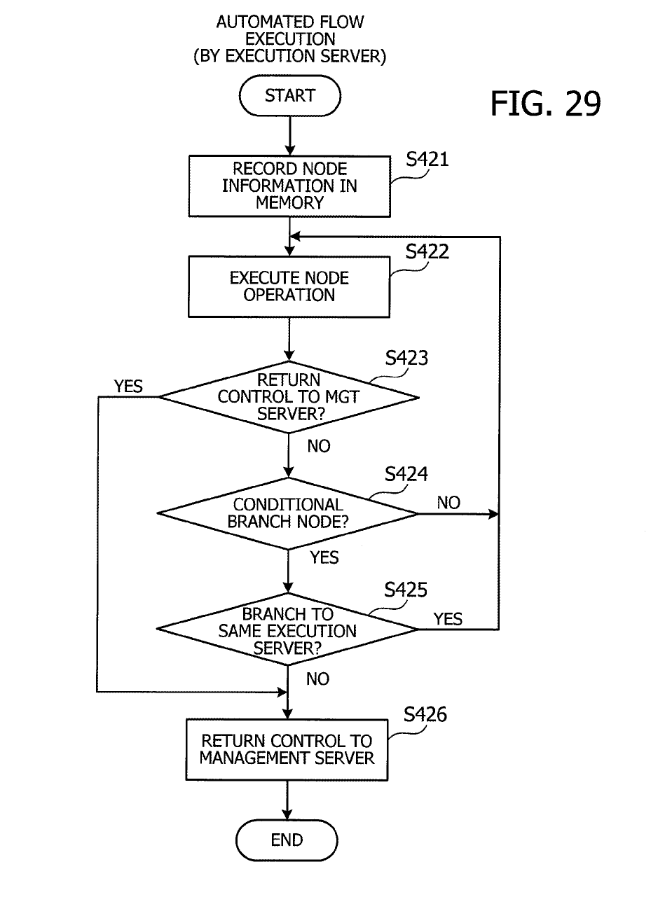

FIG. 29 is a flowchart illustrating an exemplary process of automated flow execution by an execution server. The following description assumes that one execution server 200 has received an execution request.

(Step S421) The flow execution unit 230 receives an execution request from the management server 100. This request includes information about a special node that defines a process of returning the control back to the management server 100. This returning node has been inserted in the automated flow, and its information includes the position of the inserted node. The flow execution unit 230 keeps this information in its local memory.

(Step S422) The flow execution unit 230 reads a pertinent automated flow out of the process definition storage unit 220 and locates a node to be executed. The flow execution unit 230 executes the operation of that node.

(Step S423) Upon execution of one node at step S422, the flow execution unit 230 determines whether the next node is to return the control to the management server 100. When the node in question is found to be the returning node, the process skips to step S426. Otherwise, the process advances to step S424.

(Step S424) The flow execution unit 230 determines whether the next node is a conditional branch node (i.e., a node at which the work flow takes one of a plurality of routes). When the node in question is a conditional branch node, the process advances to step S425. Otherwise, the process returns to step S422.

(Step S425) The flow execution unit 230 determines to which destination node the conditional branch node chooses. When the chosen destination node is to be executed by the execution server 200 itself, the process returns to step S422. Otherwise, the process advances to step S426.

(Step S426) The execution server 200 is here at step S426 because the returning node has been reached at step S423, or because the destination node of the conditional branch is found at step S425 to be executed by some other server. The flow execution unit 230 thus returns the control to the management server 100 by, for example, sending a completion notice for the requested operation to the management server 100.

The completion notice may include a unique identifier of the destination node of the conditional branch when this is the case, thereby informing the management server 100 which node in the automated flow has returned the control. The unique identifier may be, for example, an instance ID, which has previously been assigned for use during execution of the automated flow.

(e) Advantages of Second Embodiment

As can be seen from the above description, the proposed system executes an automated flow in an efficiently distributed manner. This is because the second embodiment determines which servers to execute processing operations, considering not only the transmission rates between the management server 100 and execution servers, but also the transmission rates between execution servers and managed servers, so that the automated flow is executed more efficiently.

The enhancement of efficiency based on consideration of transmission rates is expected to work well, particularly when a large amount of data (e.g., log files) has to be transported over networks. In such cases, the throughput of the system may vary depending on its communication performance.

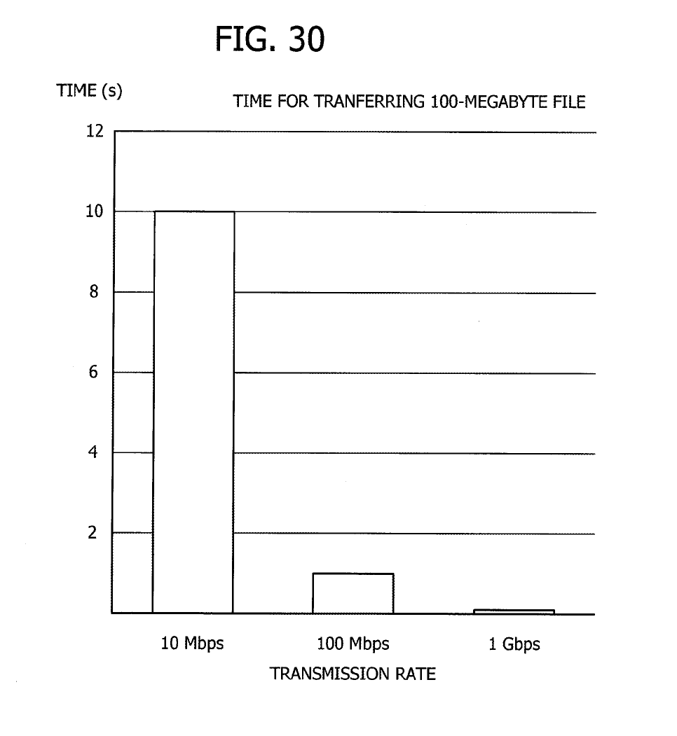

FIG. 30 illustrates how long time it takes to transfer a 100-megabyte file. When the available bandwidth of a network link is as small as 10 MB/s, it takes about ten seconds to transfer a file of 100 megabytes. A network link of 100 MB/s transfers the same file in about one second. A network link of 1 GB/s transfers the same file in about 0.1 seconds.

The total processing time of an automated flow may be reduced by distributing its workload across multiple servers. In view of, however, the significance of communication performance noted above, the expected effect of load distribution is limited if it only takes into consideration the load condition of CPU and memory resources in the servers. The second embodiment is therefore configured to distribute the workload of processing with a consideration on communication performance of servers, so that the processing operations in an automated flow can be executed efficiently even if they include transfer of massive data.

The second embodiment is also capable of combining a plurality of successive nodes into a single group and requesting execution of these nodes collectively, when it is efficient for a single execution server to execute such node operations. This feature reduces communication events between the management server and execution servers, thus contributing to more efficient processing operations.

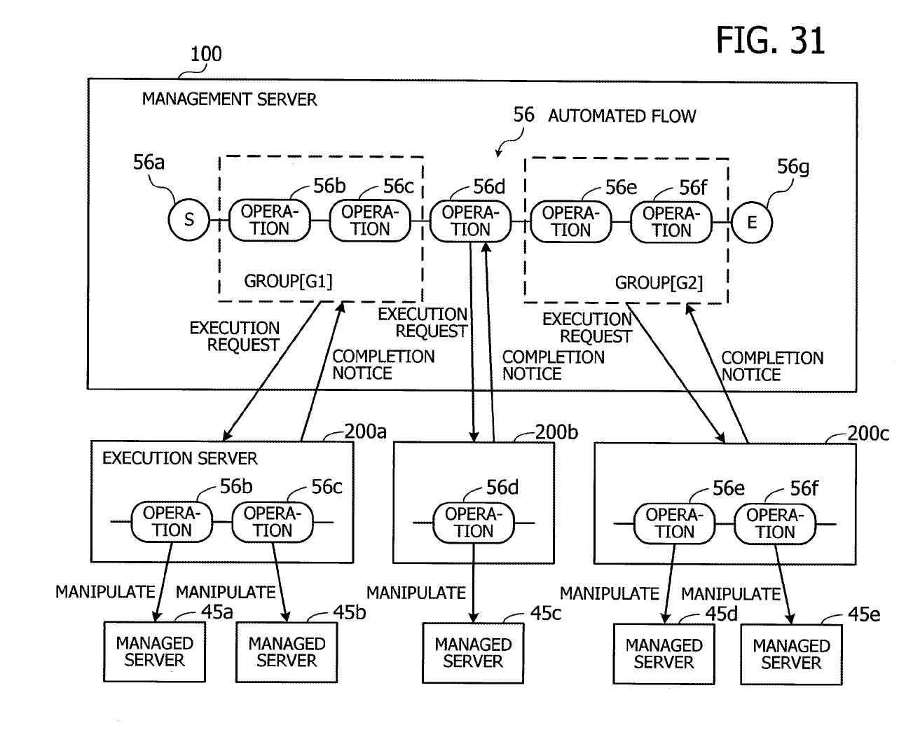

FIG. 31 illustrates an example of communication events produced during execution of grouped operations. Specifically, FIG. 31 illustrates communication between a number of servers, assuming that these servers execute an automated flow 56 including two groups of nodes discussed in FIG. 20. Upon starting the automated flow 56, the management server 100 first sends an execution request for group [G1] to one execution server 200a to delegate the operations of two nodes 56b and 56c. The execution server 200a executes operations defined at the nodes 56b and 56c accordingly, during which the execution server 200a sends commands and the like to managed servers 45a and 45b to manipulate them. The execution server 200a then returns a completion notice to the management server 100.

The completion notice from the execution server 200a causes the management server 100 to advance to a subsequent node 56d in the automated flow 56, at which the management server 100 sends an execution request for the node 56d to another execution server 200b. The requested execution server 200b then executes operations defined at the node 56d, including manipulation of a managed server 45c, and returns a completion notice to the management server 100.

The completion notice from the execution server 200b causes the management server 100 to advance the execution to a subsequent node 56e in the automated flow 56, at which the management server 100 sends an execution request for group [G2] to yet another execution server 200c to delegate the operations of two nodes 56e and 56f. The requested execution server 200c then executes operations including manipulation of managed servers 45d and 45e and returns a completion notice to the management server 100.

As can be seen from the above, the management server 100 sends an execution request to execution servers 200a, 200b, and 200c and receives a completion notice from them, each time it performs a new set of processing operations. Without node grouping, the illustrated automated flow 56 would produce five execution requests and five completion notices transmitted back and forth. The node grouping of the second embodiment reduces them to three execution requests and three completion notices. The reduced transmissions lead to a shorter total processing time of the automated flow.

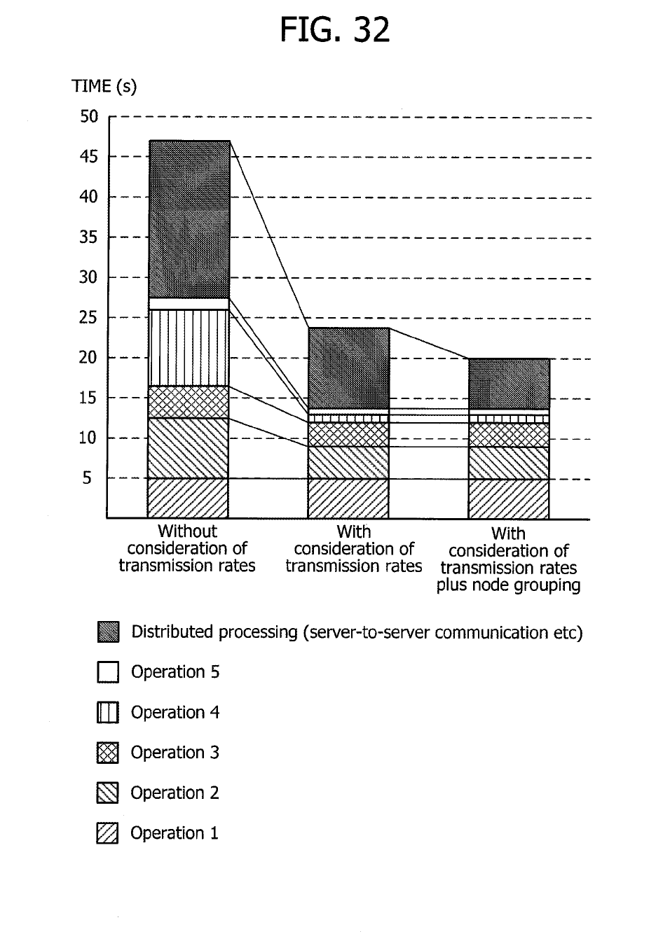

FIG. 32 illustrates how the processing times are reduced in the second embodiment. Specifically, FIG. 32 depicts the total processing time of an automated flow in the following three cases: (1) operations are distributed without consideration of transmission rates, (2) operations are distributed with consideration of transmission rates, and (3) operations are distributed in groups, with consideration of transmission rates. As can be seen from FIG. 32, the consideration of transmission rates greatly contributes to reduction of time spent for data communication between servers (e.g., time for log collection). Grouping of nodes contributes more to the time reduction, not in processing operations of individual nodes in the automated flow, but in server-to-server communication performed to distribute processing load across the servers.

The second embodiment is designed to rebuild the server assignment schedule automatically upon detection of a failure of connection with an assigned execution server. This feature helps in the case where, for example, a distributed processing system is scheduled to run at nighttime. That is, even if some of the originally scheduled execution servers are failed, the system would be able to finish the automated flow by the next morning.

Various embodiments and their variations have been discussed above. According to one aspect of the embodiments, the proposed techniques enable more efficient control of devices.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable medium storing a computer program that causes a computer to perform a process comprising:
selecting a controller apparatus from a plurality of controller apparatuses to control a controlled apparatus, based on transmission rates of communication links between the controlled apparatus and each of the plurality of controller apparatuses; and
requesting the selected controller apparatus to control the controlled apparatus.

2. The non-transitory computer-readable medium according to claim 1, wherein the process further comprises collecting, from the each of the plurality of controller apparatuses, information about the transmission rate of a communication link therefrom to the controlled apparatus.

3. The non-transitory computer-readable medium according to claim 1, wherein:
the controlled apparatus is provided in plurality;
the process further comprises obtaining definition data that defines an ordered set of operations to be performed to control the plurality of controlled apparatuses;
the selecting one of a plurality of controller apparatuses includes selecting one of the controller apparatuses for each of the operations defined in the obtained definition data; and
the requesting includes sending an execution request to the selected controller apparatuses in accordance with the order of the operations defined in the obtained definition data.

4. The non-transitory computer-readable medium according to claim 3, wherein:
the process further comprises sorting the operations into a plurality of groups, each of the plurality of groups including a series of successive operations whose selected controller apparatuses are identical; and
the requesting further including sending a collective execution request to one of the controller apparatuses that has been selected for all operations constituting one group, the collective execution request requesting execution of all the operations in the group.

5. The non-transitory computer-readable medium according to claim 4, wherein:
the definition data further defines of a plurality of operation sequences that are allowed to run in parallel with one another, each of the plurality of operation sequences including a plurality of operations to be executed one by one; and
the sorting the operations into groups includes sorting the operations belonging to different operation sequences into different groups.

6. The non-transitory computer-readable medium according to claim 4, wherein:
the definition data further defines a plurality of operation sequences, each of the plurality of operation sequences including a plurality of operations to be executed sequentially;
the definition data further defines a conditional branch that selectively executes one of the plurality of operation sequences; and
the sorting the operations into groups includes:
finding, at a beginning part of one operation sequence, one or more operations whose selected controller apparatuses are identical to the controller apparatus selected for a preceding operation immediately before the conditional branch, and
forming a group from the found one or more operations and the preceding operation immediately before the conditional branch.

7. The non-transitory computer-readable medium according to claim 3, wherein the process further comprises:
detecting a failed operation whose execution request has not reached the selected controller apparatus;
reselecting a controller apparatus being different from the selected controller apparatus from the plurality of controller apparatuses for the failed operation, as well as for a pending operation subsequent thereto, while excluding the controller apparatus that has failed to receive the execution request; and
requesting the reselected controller apparatuses to execute the failed operation and the pending operation, respectively.

8. The non-transitory computer-readable medium according to claim 1, wherein the process further comprises:
identifying one of the controller apparatuses whose communication link to the controlled apparatus has a higher transmission rate than the communication links of the other controller apparatuses;
determining a first communication time that the identified controller apparatus is expected to consume when the identified controller apparatus controls the controlled apparatus;
determining a second communication time that the computer is expected to consume when the computer controls the controlled apparatus; and
causing the computer to control the controlled apparatus when the second communication time is shorter than the first communication time.

9. A method for requesting control operations, the method comprising:
selecting, by a processor, a controller apparatus from a plurality of controller apparatuses to control a controlled apparatus, based on transmission rates of communication links between the controlled apparatus and each of the plurality of controller apparatuses; and
requesting the selected controller apparatus to control the controlled apparatus.

10. An information processing apparatus comprising a processor configured to perform a process including:
selecting a controller apparatus from a plurality of controller apparatuses to control a controlled apparatus, based on transmission rates of communication links between the controlled apparatus and each of the plurality of controller apparatuses; and
requesting the selected controller apparatus to control the controlled apparatus.
